(19) United States
(12) Patent Application Publication
(10) Pub. No.: US 2026/0260926 A1
(43) Pub. Date: Sep. 3, 2026

(54) Lithium-Ion Secondary Battery

(71) Applicant: Semiconductor Energy Laboratory Co., Ltd., Kanagawa-ken (JP)

(72) Inventors: Masayuki KIMURA, Atsugi, Kanagawa (JP); Taisuke NAKAO, Atsugi, Kanagawa (JP); Kazutaka KURIKI, Ebina, Kanagawa (JP)

(73) Assignee: Semiconductor Energy Laboratory Co., Ltd., Kanagawa-ken (JP)

(21) Appl. No.: 18/869,512

(22) PCT Filed: Jun. 5, 2023
(86) PCT No.: PCT/IB2023/055752

§ 371 Date: Nov. 26, 2024

(30) Foreign Application Priority Data
Jun. 17, 2022 (JP) 2022-098089

(51) Int. Cl. H01M 10/052; H01M 4/02; H01M 4/36; H01M 4/38; H01M 4/525; H01M 4/583; H01M 4/62; H01M 10/0563

(52) U.S. Cl. CPC H01M 10/052; H01M 4/364; H01M 4/386; H01M 4/525; H01M 4/583; H01M 4/62; H01M 10/0563; H01M 2004/021; H01M 2004/027; H01M 2004/028

(57) ABSTRACT

A lithium-ion secondary battery with excellent cycle performance and safety is provided. The lithium-ion secondary battery includes a positive electrode, a negative electrode, and an electrolyte solution. The positive electrode includes lithium cobalt oxide whose median diameter (D50) is greater than 12 μm. The lithium cobalt oxide includes magnesium in its surface portion. The negative electrode includes a graphite particle, a silicon particle, and a high molecular including a carboxy group.

### TECHNICAL FIELD

One embodiment of the present invention relates to an object, a method, or a manufacturing method. Alternatively, the present invention relates to a process, a machine, manufacture, or a composition of matter. One embodiment of the present invention relates to a power storage device including a secondary battery, a semiconductor device, a display device, a light-emitting device, a lighting device, an electronic device, or a manufacturing method thereof.

Note that an electronic device in this specification refers to all devices including power storage devices, and electro-optical devices including power storage devices, information terminal devices including power storage devices, and the like are all electronic devices.

### BACKGROUND ART

In recent years, power storage devices such as lithium-ion secondary batteries, lithium-ion capacitors, air batteries, and all-solid-state batteries have been actively developed. In particular, demand for lithium-ion secondary batteries with high output and high capacity has rapidly grown, and the lithium-ion secondary batteries are essential as rechargeable energy supply sources.

In order to increase the capacity of lithium-ion secondary batteries and improve the charge and discharge cycle performance, various researches and developments have been conducted on both positive and negative electrodes. For example, silicon-based materials are known to have higher capacity than graphite-based materials as for negative electrode active materials, and negative electrodes using silicon-based materials have been examined (See Patent Document 1, for example).

Furthermore, in order to increase the capacity of lithium-ion secondary batteries and improve their charge and discharge cycle performance at room temperature, various researches and developments have been conducted on both positive and negative electrodes. For example, as positive electrode active materials, positive electrode active materials having a stable crystal structure even after charging and discharging have been examined (see Patent Document 2, for example).

Meanwhile, lithium-ion secondary batteries are known to enter thermal runaway after passing through several states when the temperature rises (Non-Patent Document 1).

### REFERENCES

### Patent Documents

[Patent Document 1] Japanese Published Patent Application No. 2019-165005
[Patent Document 2] Japanese Published Patent Application No. 2022-070247

### Non-Patent Document

[Non-Patent Document 1] Nobuo Eda, “2-4: Mechanism of Heat Generation” in “Learning Charging and Discharging Techniques of Li-Ion Batteries from Data” [Translated from Japanese.], CQ Publishing Co., Ltd., published on Apr. 4, 2020, p. 68-72.

### SUMMARY OF THE INVENTION

### Problems to be Solved by the Invention

There is room for improvements in a variety of aspects of lithium-ion secondary batteries, such as charge and discharge capacity, charge and discharge characteristics, cycle performance, reliability, safety, and costs.

Therefore, negative electrodes and negative electrode active materials that can improve charge and discharge capacity, charge and discharge cycle performance, and the like when used in secondary batteries have been needed.

On the other hand, secondary batteries with large charge and discharge capacity can store a large amount of energy, and thus are required to have a higher level of safety.

An object of one embodiment of the present invention is to provide a highly safe or reliable lithium-ion secondary battery. Another object of one embodiment of the present invention is to provide a lithium-ion secondary battery that has excellent charge and discharge capacity and charge and discharge cycle performance and has a high level of safety or reliability.

Note that the description of these objects does not preclude the existence of other objects. One embodiment of the present invention does not need to achieve all of these objects. Other objects can be derived from the description of the specification, the drawings, and the claims.

### Means for Solving the Problems

One embodiment of the present invention is a lithium-ion secondary battery including a positive electrode, a negative electrode, and an electrolyte solution. The positive electrode includes lithium cobalt oxide whose median diameter (D50) is greater than 12 μm. The lithium cobalt oxide includes magnesium in its surface portion. The negative electrode includes a graphite particle, a silicon particle, and a high molecular including a carboxy group.

Another embodiment of the present invention is a lithium-ion secondary battery in which the average particle diameter of silicon particles is less than 1 μm.

Another embodiment of the present invention is a lithium-ion secondary battery in which the average particle diameter of graphite particles is greater than or equal to 5 μm.

Another embodiment of the present invention is a lithium-ion secondary battery in which the weight ratio of silicon particles is lower than that of graphite particles in a negative electrode.

Another embodiment of the present invention is a lithium-ion secondary battery with the above structure, in which the high molecular including the carboxy group is polyglutamic acid.

Another embodiment of the present invention is a lithium-ion secondary battery with the above structure, in which the average particle diameter of the silicon particles is smaller than the average particle diameter of the graphite particles.

Another embodiment of the present invention is a lithium-ion secondary battery with the above structure, in which lithium cobalt oxide has a layered rock-salt crystal structure belonging to the space group R-3m. The surface portion includes a basal plane having a surface parallel to the (00l) plane of the crystal structure and an edge plane having a surface in the direction intersecting the (00l) plane. When EDX linear analysis in the depth direction is performed on the lithium cobalt oxide, the basal plane has a higher magnesium concentration than the edge plane.

Another embodiment of the present invention is a lithium-ion secondary battery including a positive electrode, a negative electrode, and an electrolyte solution. The positive electrode includes lithium cobalt oxide whose median diameter (D50) is larger than 12 μm. The lithium cobalt oxide includes magnesium in its surface portion. The negative electrode includes a graphite particle, a silicon particle, and a high molecular including a carboxy group. The average particle diameter of the silicon particles is smaller than the average particle diameter of the graphite particles.

Another embodiment of the present invention is a lithium-ion secondary battery with the above structure, in which the lithium cobalt oxide has a layered rock-salt crystal structure belonging to the space group R-3m. The surface portion includes a basal plane having a surface parallel to the (00l) plane of the crystal structure and an edge plane having a surface in the direction intersecting the (00l) plane. When EDX linear analysis in the depth direction is performed on the lithium cobalt oxide, the lithium cobalt oxide includes a region where the distribution of magnesium and the distribution of nickel overlap with each other at the edge plane.

The capacity of silicon is 4200 mAh/g, which is greater than or equal to ten times as large as the capacity of graphite, 372 mAh/g; however, when only silicon is used for a negative electrode, there is a problem of drastic cycle deterioration caused by expansion and contraction of particles in charging and discharging. In order to decrease the cycle deterioration, miniaturized silicon particles is preferably used.

In the above structure, the silicon particles refer to silicon powders that are the negative electrode active material of the lithium-ion secondary battery and has an average particle diameter less than 1 μm and around 100 nm; the silicon particles are referred to as nanosilicon particles in some cases. In order to obtain silicon particles to be used, it is preferable that a silicon source be ground and particle diameters be adjusted to be uniform. The silicon particles may contain at least one of silicon, silicon oxide, and silicon alloy.

In the above structure, it is preferable that an average particle diameter of the graphite particles mixed with the silicon particles be greater than or equal to 1 μm, preferably greater than or equal to 5 μm.

The positive electrode active material with the above structure is a positive electrode active material whose crystal structure is unlikely to be broken by repeated charging and discharging or a positive electrode active material with high discharge capacity. A lithium-ion secondary battery using the positive electrode active material can be a lithium-ion secondary battery with a high level of safety or reliability.

In one embodiment of the present invention, a negative electrode active material contains both graphite particles and silicon particles. Since silicon particles are mixed and used in a negative electrode, a secondary battery with a high energy density can be achieved. Since the positive electrode active material having the above structure is a positive electrode active material enables a lithium-ion secondary battery with a high level of safety or reliability to be provided, a lithium-ion secondary battery with high energy density and a high level of safety or reliability can be obtained.

### Effect of the Invention

According to one embodiment of the present invention, a lithium-ion secondary battery with excellent charge and discharge capacity and charge and discharge cycle performance, or a secondary battery with a high level of safety or reliability can be provided. Alternatively, a secondary battery with excellent charge and discharge capacity and charge and discharge cycle performance and a high level of safety or reliability can be provided.

Note that the description of these effects does not preclude the existence of other effects. One embodiment of the present invention does not necessarily have all these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1 is a cross-sectional photograph of a negative electrode active material layer over a current collector.

FIG. 2 is a diagram illustrating an example of a formation flow of a negative electrode active material layer.

FIG. 3A is an exploded perspective view of a coin-type secondary battery, FIG. 3B is a perspective view of the coin-type secondary battery, and FIG. 3C is a cross-sectional perspective view thereof.

FIG. 4 is a diagram showing charge and discharge characteristics.

FIG. 5 is a diagram showing cycle performance.

FIG. 6A illustrates an example of a cylindrical secondary battery. FIG. 6B illustrates an example of the cylindrical secondary battery. FIG. 6C illustrates an example of a plurality of cylindrical secondary batteries, and FIG. 6D illustrates an example of a power storage system including the plurality of cylindrical secondary batteries.

FIG. 7A to FIG. 7C are diagrams illustrating examples of a secondary battery.

FIG. 8A and FIG. 8B are diagrams illustrating external appearances of a secondary battery.

FIG. 9A to FIG. 9C are diagrams illustrating a method for manufacturing a secondary battery.

FIG. 10A to FIG. 10D are diagrams illustrating examples of transport vehicles.

FIG. 11A and FIG. 11B are diagrams illustrating power storage devices of one embodiment of the present invention.

FIG. 12A is a diagram illustrating an electric bicycle, FIG. 12B is a diagram illustrating a secondary battery of the electric bicycle, and FIG. 12C is a diagram illustrating an electric motorcycle.

FIG. 13A to FIG. 13D are diagrams illustrating examples of electronic apparatuses.

FIG. 14 is a cross-sectional view of a positive electrode active material.

FIG. 15 illustrates a method for forming a positive electrode active material.

FIG. 16 is a graph showing a temperature rise in a secondary battery.

FIG. 17A and FIG. 17B are diagrams illustrating a nail penetration test.

FIG. 18 is a graph showing a temperature rise in a secondary battery when an internal short circuit occurs.

FIG. 19 is a diagram showing crystal structures of a positive electrode active material.

FIG. 20 is a diagram showing crystal structures of a conventional positive electrode active material.

FIG. 21 is a diagram showing XRD patterns calculated from crystal structures.

FIG. 22 is a diagram showing XRD patterns calculated from crystal structures.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

### Embodiment 1

In this embodiment, a lithium-ion secondary battery of one embodiment of the present invention is described with using a secondary battery including a positive electrode, a negative electrode, and an electrolyte solution as an example. In addition, a separator is included between the positive electrode and the negative electrode. In addition, the separator sometimes contains a liquid electrolyte (also referred to as an electrolyte solution). Note that in the case where a solid electrolyte or a semi-solid electrolyte is used instead of the electrolyte solution, the separator is not needed. Furthermore, an exterior body for storing the positive electrode, the negative electrode, the electrolyte solution, and the like may be included.

### [Negative Electrode]

In one embodiment of the present invention, a material in which carbon particles and a silicon-based material are mixed is used as a negative electrode active material. As a binder of them, a high molecular including a ketone group or a high molecular including a polar substituent such as a carboxy group is used to form a negative electrode active material layer.

The negative electrode active material layer is formed on one or both surfaces of a current collector for the negative electrode. The negative electrode active material layer is formed by applying slurry onto the current collector for the negative electrode. The slurry is formed in such a manner that carbon particles, silicon particles, and a binder are mixed, and water is added to the mixture.

Graphite, carbon having a layer structure like graphite, amorphous carbon, or hard carbon can be used as the carbon particles. Furthermore, carbon fiber may be used instead of the carbon particles. The carbon particles used in one embodiment of the present invention are specifically graphite particles. Graphite particles are preferable as an active material of the negative electrode because they are inexpensive because they are abundant in the nature.

In the above structure, the silicon particles have an average particle diameter of less than 1 μm and around 100 nm, and are referred to as nanosilicon particles in some cases. In order to obtain silicon particles to be used, it is preferable that a silicon source be ground and particle diameters be adjusted to be uniform. The silicon particles may contain at least one of silicon, silicon oxide, and silicon alloy.

The capacity of silicon is 4200 mAh/g, which is greater than or equal to ten times as large as the capacity of graphite, 372 mAh/g; thus, a lithium-ion secondary battery using silicon as the negative electrode active material can be a secondary battery with a high energy density. However, when only silicon is used as the negative electrode active material, there is a problem in that rapid cycle degradation occurs by expansion and contraction due to charging and discharging. In order to decrease the cycle deterioration, miniaturized silicon particles is preferably used.

In the above structure, it is preferable that an average particle diameter of the graphite particles mixed with the silicon particles be greater than or equal to 1 μm, preferably greater than or equal to 5 μm.

In one embodiment of the present invention, the negative electrode active material contains both the graphite particles and the silicon particles. Since the silicon particles are mixed and used in the negative electrode, a secondary battery with a high energy density can be achieved.

Note that the weight ratio (wt %) in this specification refers to the compounding ratio at the time of forming electrode slurry described later, i.e., the weight ratio of each of an active material, a conductive additive, and a binding agent in the total weight (the mixed powder). Therefore, each weight ratio may be different between before and after a secondary battery is formed.

Specifically, the silicon weight ratio in the total weight of the powder materials forming the negative electrode active material is greater than or equal to 7.5 wt % and less than or equal to 37.5 wt %. In the negative electrode active material layer, the weight ratio of silicon particles is made less than the weight ratio of graphite particles.

When the negative electrode active material layer is formed, a conductive additive may be added. A typical carbon material used as the conductive additive is acetylene black (also referred to as AB). Acetylene black refers to bulky particles with an average particle diameter of several tens of nanometers to several hundreds of nanometers; thus, the contact between acetylene black and another material hardly becomes surface contact and tends to be point contact. Hence, in the case where an active material and acetylene black are mixed, the contact resistance between the active material and acetylene black is high. Using a large amount of acetylene black in order to decrease the contact resistance lowers the proportion of the active material in the whole electrode, thereby reducing the discharge capacity of a secondary battery.

In addition, acetylene black is a material that is likely to aggregate and it is preferable to mix to be uniformly dispersed. The weight ratio of acetylene black is less than or equal to the weight ratio of silicon particles. Needless to say, a secondary battery can be fabricated without adding the conductive additive (acetylene black).

In the negative electrode of the secondary battery, a binder is mixed in order to fix a current collector such as metal foil and an active material. The binder is also referred to as a binding agent. Since the binder is a high molecular material, a large amount of the binder lowers the proportion of the active material in the negative electrode, thereby reducing the discharge capacity of the secondary battery. Therefore, the amount of binder mixed at the time of forming slurry is reduced to a minimum conventionally.

In one embodiment of the present invention, as a binder used in the negative electrode, polyglutamic acid, poly(acrylic acid), polyaspartic acid, carboxymethyl cellulose (CMC), alginic acid (polysaccharide), acrylic acid/maleic acid copolymer, acrylic acid/sulfonate copolymer, and polyamino acid (specifically, polyornithine or polysarcosine) can be given.

As the binder used in the negative electrode, a material that contains at least a high molecular having a double bond of carbon and oxygen (a ketone group) is preferably used. Oxygen in the ketone group has an unshared electron pair, and the unshared electron pair may assist lithium in the electrolyte solution in desolvating and entering the negative electrode active material.

As the binder used in the negative electrode, in particular, a material at least containing a high molecular including a carboxy group is preferably used, and polyglutamic acid or poly(acrylic acid) is particularly preferable. A polar substituent such as a carboxy group in the polymer may assist lithium in the electrolyte solution in desolvating and entering the negative electrode active material. Note that the substituent such as a carboxy group can be analyzed by FT-IR or the like. A material in which polymers are cross-linked is preferably used for the binder used for the negative electrode because a net-like structure can be formed in the negative electrode. The chemical formula of polyglutamic acid is shown below.

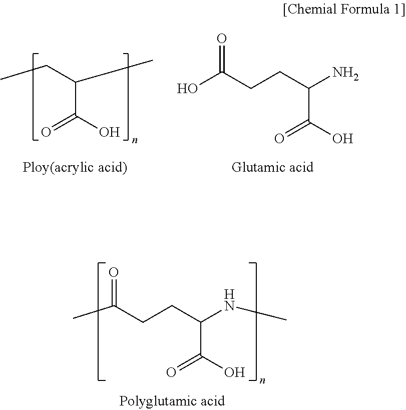

There is no particular limitation on a method for synthesizing polyglutamic acid; polyglutamic acid is minute particulate matter and a material in which γ-glutamic acid is the main component. When polyglutamic acid is put into a solvent and the solvent is stirred, the polyglutamic acid can function as a flocculant. Depending on the formation method, polyglutamic acid can be referred to as γ-glutamic acid containing another element (e.g., Ca, Al, Na, Mg, Fe, Si, or S). As long as γ-glutamic acid functions as a flocculant, it may contain another element (e.g., Ca, Al, Na, Mg, Fe, Si, or S). Furthermore, polyglutamic acid may be a cross-linking substance. The weight average molecular weight of polyglutamic acid that is a cross-linking substance can be several tens of millions. Weight average molecular weight is average molecular weight in consideration of weight fraction measured by a viscosity method (in the method, intrinsic viscosity is obtained with a capillary viscometer and calculation is performed with a viscosity formula) or a gel permeation chromatography. Furthermore, in the case where a high molecular including a carboxy group is used as the binder in the negative electrode, the weight average molecular weight of the high molecular is greater than or equal to eight hundred thousand, preferably fifteen hundred thousand, further preferably twenty-five hundred thousand.

The weight ratio of the binder is preferably less than the weight ratio of graphite particles. When the weight ratio of the binder is too low, the effect becomes small; thus, the binder is preferably greater than 5 wt %.

The negative electrode active material layer can be formed in the following manner: polyglutamic acid, graphite particles, silicon particles, and acetylene black are mixed after the weight ratios of them are adjusted, slurry is prepared by mixing the above mixture with a solvent (e.g., deionized water), and the slurry is applied to one or both surfaces of the negative electrode current collector, dried, and pressed. A lithium-ion secondary battery including the negative electrode including this negative electrode active material layer can have excellent cycle performance.

Silicon particles are preferably used in the negative electrode in order to prevent oxidation; a mixing process of the silicon particles and polyglutamic acid, graphite particles, and acetylene black is preferably performed in order to prevent oxidation of the silicon particles.

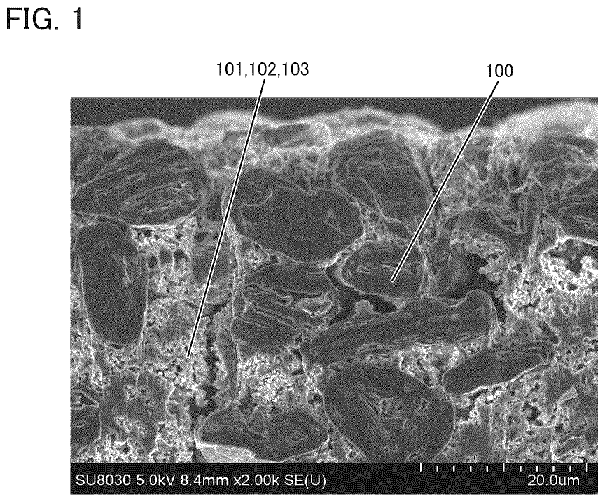

FIG. 1 shows a cross-sectional photograph of the negative electrode active material layer of this embodiment.

FIG. 1 shows the cross section of the negative electrode active material layer in a state where the slurry is applied over the negative electrode current collector and then dried. As shown in FIG. 1, a binder 102, silicon particles 101 serving as aggregates, or an AB 103 can be observed between graphite particles 100.

As the binder 102, a material at least containing a high molecular including a carboxy group is preferably used, and polyglutamic acid is used in this embodiment.

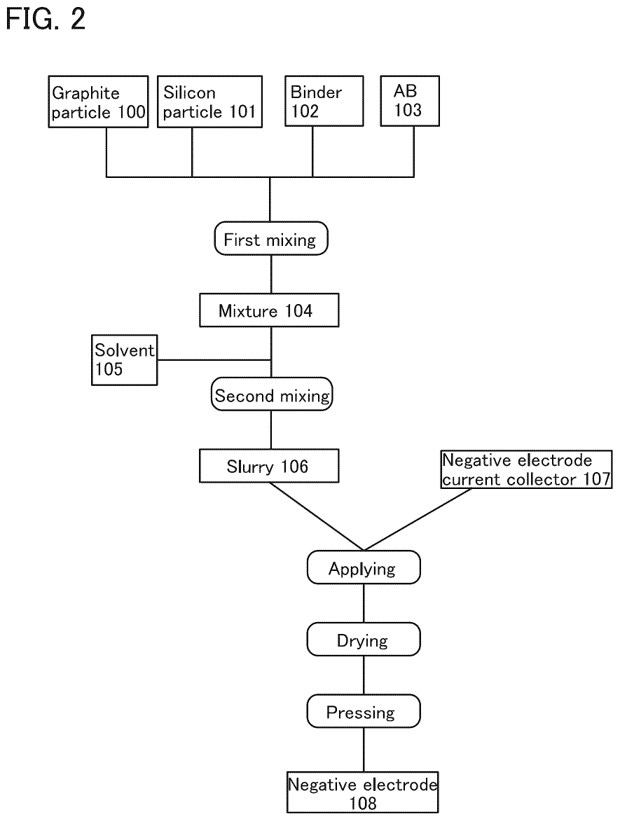

FIG. 2 shows an example of a formation flow of the negative electrode active material layer of this embodiment.

First, the graphite particle 100, the silicon particle 101, the binder 102, and the AB 103 are prepared. Next, each of them are weighed and first mixing is performed. Specifically, the weight ratio of the silicon particle 101 in the total weight of powders mixed in the first mixing is greater than or equal to 7.5 wt % and less than or equal to 37.5%, and the weight ratio of the binder 102 in the total weight is greater than or equal to 10 wt % and less than or equal to 50 wt %. Furthermore, the weight ratio of the AB 103 in the total weight is greater than or equal to 0 wt % and less than or equal to 20 wt %.

For example, the silicon particle 101, the graphite particle 100, the binder 102, and the AB 103 are weighed so that the weight ratio becomes 3:5:1:1. Alternatively, for example, AB is not used and the silicon particle 101, the graphite particle 100, and the binder 102 are weighed so that the weight ratio becomes 3:5:1. The graphite particle 100, the silicon particle 101, and the binder 102 may be weighed so that the weight ratio becomes 9:1:1.

After the first mixing, a solvent 105 is added to a mixture 104 that is a powder and second mixing is performed; whereby, slurry 106 is formed. Deionized water is used as the solvent 105. The second mixing may also be referred to as slurry preparation.

The slurry 106 refers to a material solution that is used to form an active material layer over the current collector and includes at least an active material, a binder, and a solvent, preferably also a conductive additive mixed therewith if necessary. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

Then, the slurry 106 is applied over a negative electrode current collector 107. Then, the slurry is dried. After the drying, pressing treatment is further performed. Heating may be performed at the same time as the pressing treatment.

Through the above steps, a negative electrode 108 in which the negative electrode active material layer is provided over the negative electrode current collector 107 can be formed.

A secondary battery including the negative electrode 108 obtained in the above manner has high discharge capacity and shows excellent cycle performance.

### [Positive Electrode]

Next, an example of a positive electrode active material 200 used for the positive electrode and a method for forming the positive electrode active material 200 will be described below.

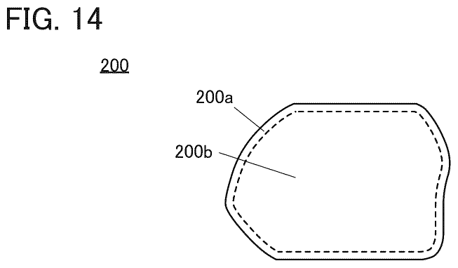

FIG. 14 is a cross-sectional view of the positive electrode active material 200. The positive electrode active material 200 is lithium cobalt oxide having a median diameter (D50) of greater than 12 μm and containing magnesium in its surface portion.

The positive electrode active material 200 may further contain nickel and/or aluminum in the surface portion. Nickel preferably exists on a plane where a diffusion path of lithium ions is exposed (also referred to as an edge plane or a plane other than a (001) plane of lithium cobalt oxide). In addition, a region containing magnesium and a region containing nickel preferably overlap with each other, connected to each other, or combined with each other on the plane through which lithium ions can be inserted and extracted, that is, the plane other than the (001) plane. This structure makes it possible to inhibit release of oxygen from the positive electrode active material or a structural change of the positive electrode active material.

The positive electrode active material 200 includes a surface portion 200a and an inner portion 200b. In the drawing, the dashed line denotes a boundary between the surface portion 200a and the inner portion 200b.

In this specification and the like, the surface portion 200a refers to a region ranging from the surface to 10 nm toward the inner portion of the positive electrode active material. A plane generated by a crack may also be referred to as a surface.

The surface portion 200a preferably has a higher concentration of an additive element, which is described later, than the inner portion 200b. The additive element preferably has a concentration gradient. In the case where a plurality of additive elements are included, the additive elements preferably exhibit concentration peaks at different depths from a surface. It is preferable that the crystal structure continuously change from the inner portion 200b toward the surface owing to the above-described concentration gradient of the additive element.

Specifically, the positive electrode active material preferably contains lithium cobalt oxide containing magnesium as the additive element and has a median diameter (D50) of greater than 12 μm. The detected amount of magnesium in the surface portion of the positive electrode active material is preferably larger than the detected amount of magnesium in the inner portion of the positive electrode active material.

### <Contained Element>

The positive electrode active material 200 contains lithium, cobalt, oxygen, and an additive element.

As the added element contained in the positive electrode active material 200, at least one of magnesium, fluorine, nickel, aluminum, titanium, zirconium, vanadium, iron, manganese, chromium, niobium, cobalt, arsenic, zinc, silicon, sulfur, phosphorus, and boron is preferably used, and specifically magnesium and aluminum are preferable. Such additive elements further stabilize the crystal structure of the positive electrode active material 200.

The additive element is preferably dissolved in the positive electrode active material 200. Thus, in STEM-EDX line analysis, for example, a depth at which the amount of a detected additive element increases is preferably at a deeper level than a depth at which the amount of the detected cobalt increases, i.e., on the inner portion side of the positive electrode active material 200.

In order that the surface portion 200a can have a stable composition and a stable crystal structure, the surface portion 200a preferably contains an additive element, further preferably contains a plurality of additive elements. The surface portion 200a preferably has a higher concentration of one or more selected from the additive elements than the inner portion 200b. The one or more selected from the additive elements contained in the positive electrode active material 200 preferably have a concentration gradient. In addition, it is further preferable that the additive elements contained in the positive electrode active material 200 be differently distributed. For example, it is further preferable that peaks of the detected amounts of the added elements in the surface portion be exhibited at different depths from the surface or the reference point in EDX line analysis described later.

At least magnesium among the additive elements preferably has the larger detected amount in the surface portion 200a than in the inner portion 200b. The peak of the detected amount of magnesium is further preferably located in a region of the surface portion 200a that is closer to the surface and preferably has a narrow width. For example, the peak of the detected amount of magnesium is preferably located in a region ranging from the surface or the reference point to 3 nm or less. Similarly, the detected amounts of nickel, fluorine, titanium, silicon, phosphorus, boron, and/or calcium are/is also preferably larger in the surface portion 200a than in the inner portion. The peaks of the detected amounts are preferably located in a region of the surface portion 200a that is closer to the surface. For example, the peaks of the detected amounts are preferably located in a region ranging from the surface or the reference point to 3 nm or less.

A peak of the detected amount of at least aluminum among the additive elements is preferably observed in a region that is located inward from a region in which a peak of the detected amount of magnesium is observed. The distributions of magnesium and aluminum may or may not overlap with each other. The peak of the detected amount of aluminum may be located in the surface portion 200a or located deeper than the surface portion 200a. For example, the peak is preferably located in a region ranging from 5 nm to 30 nm, both inclusive, in depth toward the inner portion from the surface or the reference point.

Additive elements that are differently distributed are preferably contained at a time, in which case the crystal structure in a wider region can be stabilized. For example, the stable crystal structure can be obtained in a wider region in the case where the positive electrode active material 200 contains, in the surface portion 200a, magnesium and nickel distributed in a region closer to the surface and aluminum distributed in a region deeper than magnesium and nickel, than in the case where only one or two of the additive elements are contained.

When a plurality of the additive elements are contained as described above, the effects of the additive elements contribute synergistically to further stabilization of the surface portion 200a. In particular, magnesium, nickel, and aluminum are preferably contained, in which case a high effect of stabilizing the composition and the crystal structure can be obtained.

A too large particle diameter of the positive electrode active material 200 causes problems such as difficulty in lithium diffusion and too much surface roughness of an active material layer in coating a current collector. In contrast, a too small particle size causes problems such as over-reaction with an electrolyte solution. Thus, the median diameter (D50) is preferably greater than or equal to 12 μm and less than or equal to 100 μm, further preferably greater than or equal to 12 μm and less than or equal to 40 μm, still further preferably greater than or equal to 12 μm and less than or equal to 30 μm.

Note that when x in LiₓCoO₂ is approximately 0.2, such a positive electrode active material belongs to a trigonal space group R-3m and has the O3′ type crystal structure in which the symmetry of the CoO₂ layers is the same as that in O3.

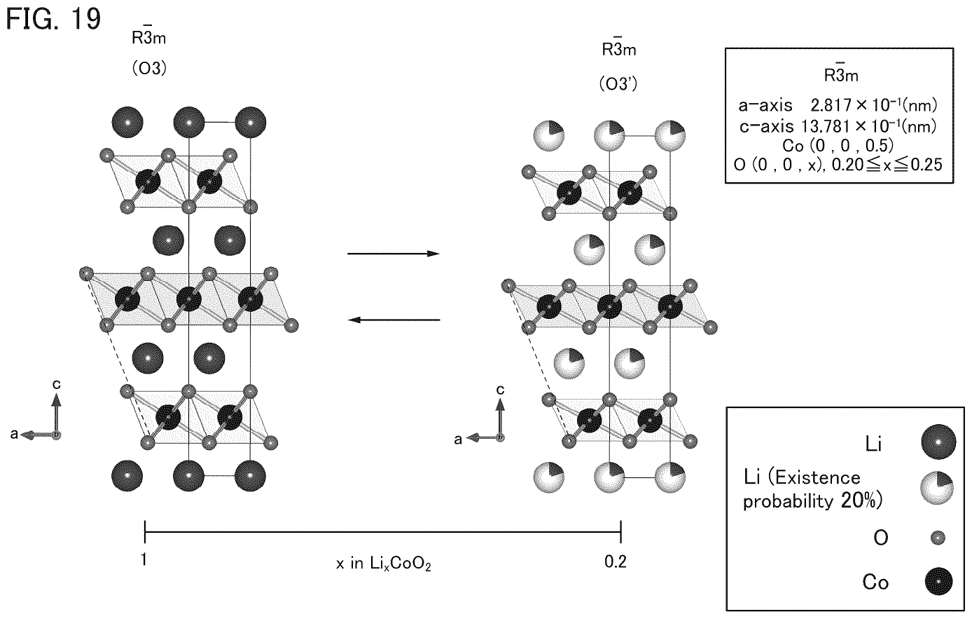

A conventional positive electrode active material and the positive electrode active material 200 of one embodiment of the present invention are compared and changes in crystal structures owing to a change in x in LiₓCoO₂ will be described with reference to FIG. 19 to FIG. 22.

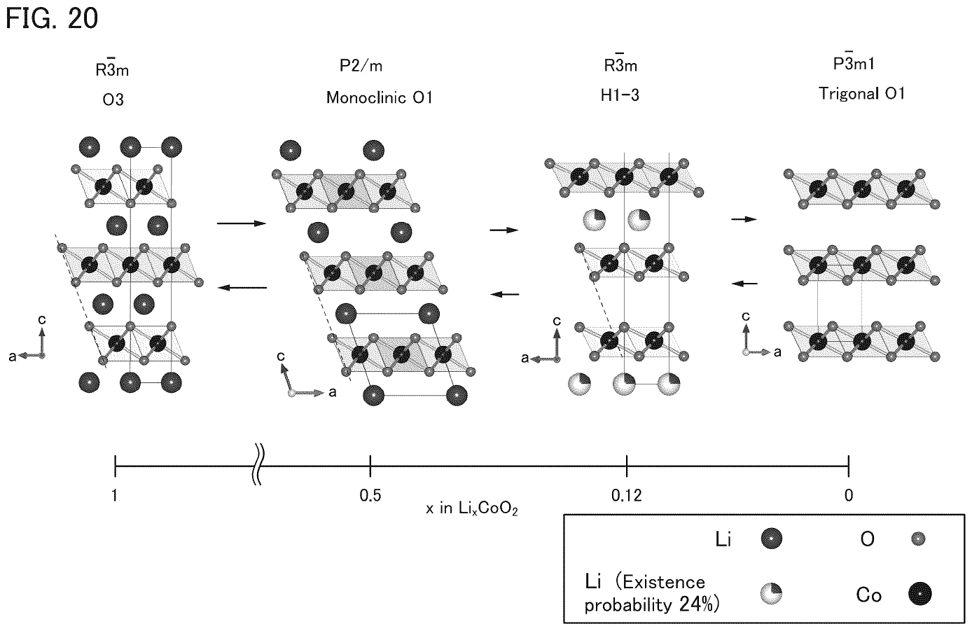

A change in the crystal structure of the conventional positive electrode active material is shown in FIG. 20. The conventional positive electrode active material shown in FIG. 20 is lithium cobalt oxide (LiCoO₂) without magnesium in particular.

In FIG. 20, the crystal structure of lithium cobalt oxide with x in LiₓCoO₂ of 1 is denoted by R-3m O3. In this crystal structure, lithium occupies octahedral sites and a unit cell includes three CoO₂ layers. Thus, this crystal structure is referred to as an O3 type crystal structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x being approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x being 0 has the trigonal crystal structure belonging to the space group P-3 ml and includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when the trigonal crystal is converted into a composite hexagonal lattice.

Conventional lithium cobalt oxide with x being approximately 0.12 has the crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that the number of cobalt atoms per unit cell in the actual H1-3 type crystal structure is twice that in other structures. However, in this specification including FIG. 20, the c-axis of the H1-3 type crystal structure is half that of the unit cell for easy comparison with the other crystal structures.

For the H1-3 type crystal structure, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. A unit cell that should be used for representing a crystal structure in a positive electrode active material can be judged by the Rietveld analysis of XRD patterns, for example. In this case, a unit cell is selected such that the value of GOF (goodness of fit) is small, specifically, GOF is close to 1.

When charging that makes x in LiₓCoO₂ be 0.24 or less and discharging are repeated, the crystal structure of conventional lithium cobalt oxide repeatedly changes between the R-3m O3 type crystal structure in a discharged state and the H1-3 type crystal structure (i.e., an unbalanced phase change).

However, there is a large shift in the CoO₂ layers between these two crystal structures. As denoted by the dotted lines and the arrows in FIG. 20, the CoO₂ layer in the H1-3 type crystal structure largely shifts from that in R-3m O3 in a discharged state. Such a dynamic structural change can adversely affect the stability of the crystal structure.

A difference in volume between these two crystal structures is also large. The difference in volume per the same number of cobalt atoms between the R-3m O3 type crystal structure in a discharged state and the H1-3 type crystal structure is greater than 3.5%, typically greater than or equal to 3.9%.

In addition, a structure in which CoO₂ layers are arranged continuously, such as the trigonal O1 type structure, included in the H1-3 type crystal structure is highly likely to be unstable.

Accordingly, when charging that makes x be 0.24 or less and discharging are repeated, the crystal structure of conventional lithium cobalt oxide is gradually broken. The broken crystal structure triggers degradation of the cycle performance. This is because the broken crystal structure has a smaller number of sites where lithium can exist stably and makes it difficult to insert and extract lithium.

On the other hand, in the positive electrode active material 200 of one embodiment of the present invention shown in FIG. 19, a change in the crystal structure between a discharged state with x in LiₓCoO₂ being 1 and a state with x being 0.24 or less, specifically a state with x being 0.2 (this is sometimes referred to as Li existence probability of 20%), is smaller than that in a conventional positive electrode active material. Specifically, a shift in the CoO₂ layers between the state with x being 1 and the state with x being 0.24 or less can be small. Furthermore, a change in the volume can be small in the case where the positive electrode active materials have the same number of cobalt atoms. Thus, the positive electrode active material 200 of one embodiment of the present invention can have a crystal structure that is difficult to break even when charge that makes x be 0.24 or less and discharge are repeated, and enables excellent cycle performance. In addition, the positive electrode active material 200 of one embodiment of the present invention with x in LiₓCoO₂ being 0.24 or less can have a more stable crystal structure than a conventional positive electrode active material. Thus, the positive electrode active material 200 of one embodiment of the present invention with x in LiₓCoO₂ being kept at 0.24 or less inhibits a short circuit. This is preferable because the safety of the lithium-ion secondary battery is improved.

FIG. 19 shows crystal structures of the inner portion 200b of the positive electrode active material 200 in a state where x in LiₓCoO₂ is 1 and in a state where x in LiₓCoO₂ is approximately 0.2. The inner portion 200b, accounting for the majority of the volume of the positive electrode active material 200, largely contributes to charge and discharge and is accordingly a portion where a shift in CoO₂ layers and a volume change matter most.

The positive electrode active material 200 with x being 1 has the R-3m O3 type crystal structure, which is the same as that of conventional lithium cobalt oxide.

However, the positive electrode active material 200 has a crystal structure different from the H1-3 type crystal structure in a state where x is 0.24 or less, e.g., approximately 0.2 or approximately 0.12, with which conventional lithium cobalt oxide has the H1-3 type crystal structure.

The positive electrode active material 200 of one embodiment of the present invention with x being approximately 0.2 has a trigonal crystal structure belonging to the space group R-3m. The symmetry of the CoO₂ layers of this structure is the same as that of O3. Thus, this crystal structure is called an O3′ type crystal structure. Although the positive electrode active material 200 of one embodiment of the present invention with x being approximately 0.2 does not have a spinel structure, an XRD pattern similar to that of the spinel structure appears in some cases, and this crystal structure is referred to as a pseudo-spinel structure in some cases. In FIG. 19, this crystal structure is denoted by R-3m O3′.

In the unit cell of the O3′ type crystal structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (×10⁻¹ nm), further preferably 2.807≤a≤2.827 (×10⁻¹ nm), typically a=2.817 (×10⁻¹ nm). The lattice constant of the c-axis is preferably 13.681≤c≤13.881 (×10⁻¹ nm), further preferably 13.751≤c≤13.811, typically c=13.781 (×10⁻¹ nm).

Note that in the O₃′ type crystal structure, an ion of cobalt, magnesium, or the like occupies a site coordinated to six oxygen atoms. Note that a light element such as lithium sometimes occupies a site coordinated to four oxygen atoms.

As denoted by the dotted lines in FIG. 19, the CoO₂ layers hardly shift between the R-3m (O3) in a discharged state and the O3′ type crystal structure.

The R-3m (O3) type crystal structure in a discharged state and the O3′ type crystal structure which contain the same number of cobalt atoms have a difference in volume of 2.5% or less, specifically 2.2% or less, typically 1.8%.

As described above, in the positive electrode active material 200 of one embodiment of the present invention, a change in the crystal structure caused when x in LiₓCoO₂ is small, i.e., when a large amount of lithium is extracted, is smaller than that in a conventional positive electrode active material. In addition, a change in the volume per the same number of cobalt atoms is inhibited. Thus, the crystal structure of the positive electrode active material 200 is unlikely to be broken even when charging that makes x be 0.24 or less and discharging are repeated. Therefore, the positive electrode active material 200 inhibits a decrease in charge and discharge capacity in charge and discharge cycles. Furthermore, the positive electrode active material 200 can stably use a larger amount of lithium than a conventional positive electrode active material and thus enables high discharge capacity per weight and per volume. Thus, with use of the positive electrode active material 200, a lithium-ion secondary battery with high discharge capacity per weight and per volume can be fabricated.

Note that the positive electrode active material 200 is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27. However, the crystal structure is influenced by not only x in LiₓCoO₂ but also the number of charge and discharge cycles, a charge current and a discharge current, temperature, an electrolyte solution, and the like, so that the range of x is not limited to the above.

Hence, when x in LiₓCoO₂ in the positive electrode active material 200 is greater than 0.1 and less than or equal to 0.24, not all of the inner portion 200b of the positive electrode active material 200 has to have the O3′ type crystal structure. The positive electrode active material may include another crystal structure or may be partly amorphous.

In order to make x in LiₓCoO₂ small, charge at a high charge voltage is necessary in general. Thus, the state where x in LiₓCoO₂ is small can be rephrased as a state where charge at a high charge voltage has been performed.

Thus, the positive electrode active material 200 of one embodiment of the present invention is preferable because the crystal structure with the symmetry of R-3m O3 can be maintained even when charging at a high charge voltage of 4.6 V or higher is performed at 25° C., for example. Moreover, the positive electrode active material 200 of one embodiment of the present invention is preferable because the O3′ type crystal structure can be obtained when charging with a higher charge voltage, e.g., a voltage higher than or equal to 4.65 V and lower than or equal to 4.7 V is performed at 25° C.

In the positive electrode active material 200, when the charge voltage is increased, the H1-3 type crystal is eventually observed in some cases. As described above, the crystal structure is influenced by the number of charge and discharge cycles, a charge current and a discharge current, an electrolyte solution, and the like, so that the positive electrode active material 200 of one embodiment of the present invention sometimes has the O3′ type crystal structure even at a lower charge voltage, e.g., a charge voltage of higher than or equal to 4.5 V and lower than 4.6 V at 25° C.

Note that in the case where graphite is used as a negative electrode active material in a lithium-ion secondary battery, for example, the voltage of the lithium-ion secondary battery is lower than the above-mentioned voltage by the potential of graphite. The potential of graphite is approximately 0.05 V to 0.2 V with reference to the potential of a lithium metal. Thus, for a lithium-ion secondary battery using graphite as a negative electrode active material, a similar crystal structure is obtained at a voltage obtained by subtracting the potential of the graphite from the above-described voltage.

Although a chance of the existence of lithium is the same in all lithium sites in O3′ in FIG. 19, one embodiment of the present invention is not limited thereto. Lithium may exist unevenly in only some of the lithium sites; for example, lithium may symmetrically exist as in the monoclinic O1 (Li_{0.5}CoO₂) shown in FIG. 20. Distribution of lithium can be analyzed by neutron diffraction, for example.

To obtain the O3′ type structure, a plurality of portions of the surface portion 200a of the positive electrode active material 200 preferably have similar concentration gradients of magnesium. In other words, it is preferable that the reinforcement derived from magnesium uniformly occurs in the surface portion 200a. When only part of the surface portion 200a is reinforced, stress might be concentrated on parts that do not have reinforcement. The concentration of stress on part of the positive electrode active material 200 might cause defects such as cracks from that part, leading to cracking of the positive electrode active material and a decrease in discharge capacity. Note that magnesium do not necessarily have similar concentration gradients throughout the surface portion 200a of the positive electrode active material 200.

In a layered rock-salt crystal structure belonging to R-3m, cations are arranged parallel to the (001) plane. In other words, CoO₂ layers and lithium layers are alternately stacked parallel to the (001) plane. Accordingly, a diffusion path of lithium ions also exists parallel to the (001) plane. Thus, the (001) plane is referred to as a basal plane, and a plane, where a diffusion path of lithium ions is exposed, other than the (001) plane is referred to as an edge plane.

Since the CoO₂ layer is relatively stable, the (001) plane where the CoO₂ layer exists in a surface is relatively stable. A main diffusion path of lithium ions in charging and discharging is not exposed at the (001) plane.

By contrast, a diffusion path of lithium ions is exposed at a surface other than the (001) plane. Thus, the surface other than the (001) plane and the surface portion 200a including the surface easily lose stability because they are regions where extraction of lithium ions starts as well as important regions for maintaining a diffusion path of lithium ions. It is thus extremely important to reinforce the surface other than the (001) plane and the surface portion 200a including the surface so that the crystal structure of the whole positive electrode active material 200 is maintained.

### <Analysis Method>

Whether or not a given positive electrode active material is the positive electrode active material 200 of one embodiment of the present invention, which has the O3′ type crystal structure when x in LiₓCoO₂ is small, can be judged by analyzing a positive electrode including the positive electrode active material with small x in LiₓCoO₂ by XRD, electron diffraction, neutron diffraction, electron spin resonance (ESR), nuclear magnetic resonance (NMR), or the like. A diffraction peak reflecting the crystal structure of the inner portion 200b of the positive electrode active material 200, which accounts for the majority of the volume of the positive electrode active material 200, is obtained through XRD, in particular, powder XRD.

In addition, in the case where x is too small, e.g., 0.1 or less, or under the condition where charge voltage is higher than 4.9 V, the positive electrode active material 200 of one embodiment of the present invention sometimes has the H1-3 type crystal structure or the trigonal O1 type crystal structure. Thus, determining whether or not a positive electrode active material is the positive electrode active material 200 of one embodiment of the present invention requires analysis of the crystal structure by XRD and other methods and data such as charge capacity or charge voltage.

A positive electrode active material with small x sometimes causes a change in the crystal structure when exposed to the air. For example, the O3′ type crystal structure changes into the H1-3 type crystal structure in some cases. For that reason, all samples subjected to analysis of crystal structures are preferably handled in an inert atmosphere such as an argon atmosphere.

Whether the distribution of the additive element contained in a positive electrode active material is in the above-described state can be judged by, for example, analysis using XPS, energy dispersive X-ray spectroscopy (EDX), EPMA (electron probe microanalysis), or the like.

The crystal structure of the surface portion 200a, a crystal grain boundary, or the like can be analyzed by electron diffraction of a cross section of the positive electrode active material 200, for example.

### <<Charge Method>>

Charge for determining whether or not a composite oxide is the positive electrode active material 200 of one embodiment of the present invention can be performed on a coin cell (CR2032 type with a diameter of 20 mm and a height of 3.2 mm) with a lithium counter electrode, for example.

More specifically, a positive electrode can be formed by application of slurry in which the positive electrode active material, a conductive material, and a binder are mixed to a positive electrode current collector made of aluminum foil.

A lithium metal can be used for a counter electrode.

As a lithium salt, 1 mol/L lithium hexafluorophosphate (LiPF₆) can be used, and as an electrolyte, a mixed solvent in which ethylene carbonate (EC) and diethyl carbonate (DEC) are mixed at a volume ratio of 3:7 and in which vinylene carbonate (VC) is mixed in the mixed solvent at 2 wt % as an additive agent can be used.

As a separator, a 25-μm-thick polypropylene porous film can be used.

Stainless steel (SUS) can be used for a positive electrode can and a negative electrode can.

The coin cell fabricated under the above conditions is charged with a given voltage (e.g., 4.5 V, 4.55 V, 4.6 V, 4.65 V, 4.7 V, 4.75 V, or 4.8 V). The charge method is not particularly limited as long as charge with a given voltage can be performed for sufficient time. In the case of CCCV charge, for example, CC charge can be performed with a current higher than or equal to 20 mA/g and lower than or equal to 100 mA/g. CV charge can be ended with a current higher than or equal to 2 mA/g and lower than or equal to 10 mA/g. To observe a phase change of the positive electrode active material, charging with such a small current value is preferably performed. The temperature is set to 25° C. After charge is performed in this manner, the coin cell is disassembled in a glove box with an argon atmosphere to take out the positive electrode, whereby the positive electrode active material with predetermined charge capacity can be obtained. In order to inhibit a reaction with components in the external environment, the positive electrode is preferably enclosed in an argon atmosphere in performing various analyses later. For example, XRD can be performed on the positive electrode enclosed in an airtight container with an argon atmosphere. After charging is completed, the positive electrode is preferably taken out immediately and subjected to the analysis. Specifically, the positive electrode is preferably subjected to analysis within an hour, further preferably within 30 minutes after the completion of charging.

In the case where the crystal structure in a charged state after charge and discharge are performed multiple times is analyzed, the conditions of the charge and discharge performed multiple times may be different from the above-described charge conditions. For example, as the charging, constant current charging to a given voltage (e.g., 4.6 V, 4.65 V, 4.7 V, 4.75 V, or 4.8 V) at a current value higher than or equal to 20 mA/g and lower than or equal to 100 mA/g can be performed and then constant voltage charging can be performed until the current value becomes higher than or equal to 2 mA/g and lower than or equal to 10 mA/g, and as the discharging, constant current discharging can be performed at higher than or equal to 20 mA/g and lower than or equal to 100 mA/g to 2.5 V.

Also in the case where the crystal structure in a discharged state after charging and discharging are performed multiple times is analyzed, constant current discharging can be performed at a current value higher than or equal to 20 mA/g and lower than or equal to 100 mA/g to 2.5 V, for example.

### <XRD>

The apparatus and conditions of the XRD measurement are not particularly limited as long as the appropriate adjustment and calibration are performed. The measurement can be performed with the apparatus and conditions as described below, for example. XRD apparatus: D8 ADVANCE produced by Bruker AXS
X-ray source: Cu
Output: 40 kV, 40 mA
Angle of divergence: Div. Slit, 0.5°
Detector: LynxEye
Scanning method: 2θ/θ continuous scan
Measurement range (2θ): from 15° to 90°
Step width (2θ): 0.01°
Counting time: 1 second/step
Rotation of sample stage: 15 rpm

As a standard sample used for the adjustment and calibration, a standard sintered alumina plate SRM 1976 from National Institute of Standards and Technology (NIST) can be used, for example.

In the case where the measurement sample is a powder, the sample can be set by, for example, being put on a glass sample holder or being sprinkled on a reflection-free silicon plate to which grease is applied. In the case where the measurement sample is a positive electrode, the positive electrode can be set by being attached to a substrate with a double-sided adhesive tape such that the position of the positive electrode active material layer can be adjusted to the measurement plane required by the apparatus.

Characteristic X-rays may be monochromatized with the use of a filter or the like or may be monochromatized with XRD data analysis software after an XRD pattern is obtained. For example, a peak due to CuKα₂ radiation can be eliminated and only a peak due to CuKα₁ radiation can be extracted by using DEFFRAC.EVA (XRD data analysis software produced by Bruker Corporation). This software can also be used to eliminate the background, for example.

In this specification and the like, the value of 2θ of a diffraction peak refers to the value of 2θ at which the peak top of the diffraction peak appears in an XRD pattern after the calculation model is fitted. There is no particular limitation on the crystal structure analysis software used for the fitting; for example, it is possible to use TOPAS ver. 3 (crystal structure analysis software produced by Bruker Corporation).

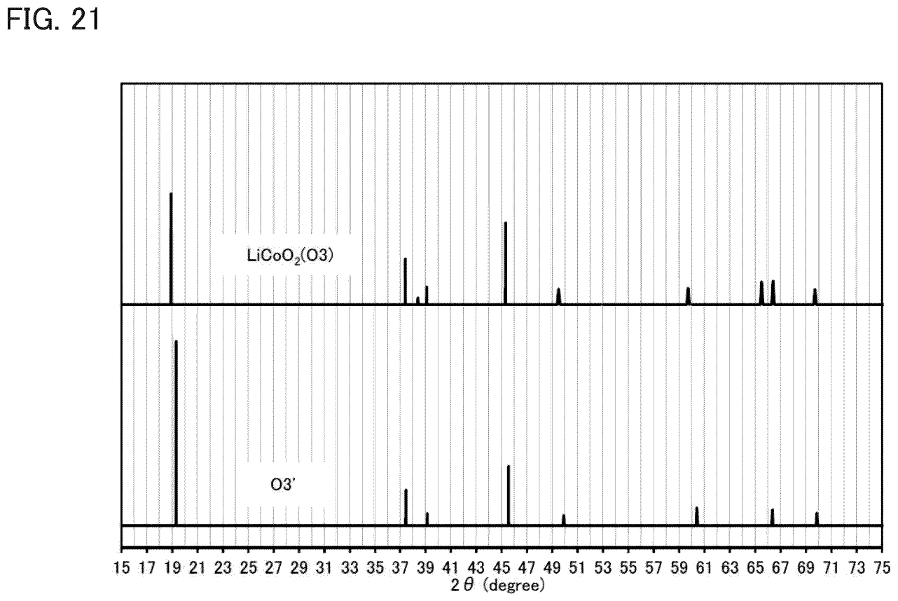

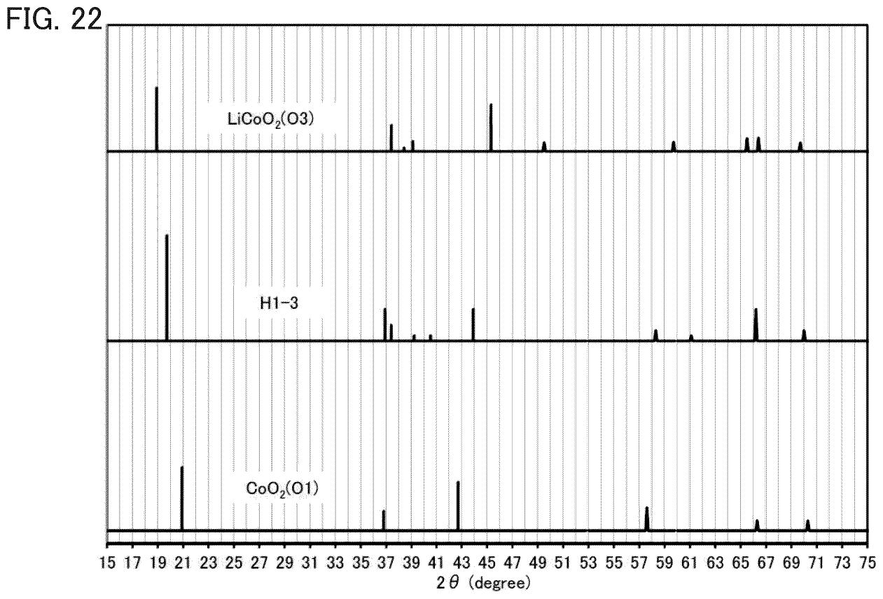

FIG. 21 and FIG. 22 show ideal powder XRD patterns (2θ (degree)) with CuKα1 radiation that are calculated from models of the O3′ type crystal structure and the H1-3 type crystal structure. For comparison, ideal XRD patterns calculated from the crystal structure of LiCoO₂ O3 with x in LiₓCoO₂ of 1 and the crystal structure of the trigonal O1 with x of 0 are also shown. Note that the patterns of LiCoO₂ (O3) and CoO₂ (O1) are made from crystal structure data obtained from ICSD (Inorganic Crystal Structure Database) using Reflex Powder Diffraction, which is a module of Materials Studio (BIOVIA). The 2θ range is from 15° to 75°, the step size is 0.01, the wavelength λ1 is 1.540562×10⁻¹⁰ m, the wavelength λ2 is not set, and a single monochromator is used. XRD patterns of the H1-3 type crystal structure are made from crystal structure data of the H1-3 type crystal structure illustrated in FIG. 22 in a manner similar to the above-described method. The O3′ type crystal structure is estimated from the XRD pattern of the positive electrode active material of one embodiment of the present invention, the crystal structure is fitted with TOPAS ver. 3 (crystal structure analysis software produced by Bruker Corporation), and the XRD pattern of the O3′ type crystal structure is made in a manner similar to that for other structures.

As shown in FIG. 21, the O3′ type crystal structure exhibits diffraction peaks at 2θ of 19.25±0.12° (greater than or equal to 19.13° and less than or equal to) 19.37° and 2θ of 45.47±0.10° (greater than or equal to 45.37° and less than or equal to 45.57°).

However, as shown in FIG. 22, the H1-3 type crystal structure and trigonal O1 do not exhibit peaks at these positions. Thus, the diffraction peaks at 2θ of 19.25±0.12° (greater than or equal to 19.13° and less than or equal to) 19.37° and 2θ of 45.47±0.10° (greater than or equal to 45.37° and less than or equal to 45.57°) in a state where x in LiₓCoO₂ is small can be the features of the positive electrode active material 200 of one embodiment of the present invention.

It can be said that the positions of the XRD diffraction peaks exhibited by the crystal structure with x being 1 and the crystal structure with x being 0.24 or less are close to each other. More specifically, it can be said that a difference in 2θ between the main diffraction peak exhibited by the crystal structure with x=1 and the main diffraction peak exhibited by the crystal structure with x≤0.24, which are exhibited at 2θ of greater than or equal to 42° and less than or equal to 46°, is 0.7° or less, preferably 0.5° or less.

Although the positive electrode active material 200 of one embodiment of the present invention has the O3′ type crystal structure when x in LiₓCoO₂ is small, not all the positive electrode active materials 200 necessarily have the O3′ type crystal structure. The positive electrode active material may include another crystal structure or may be partly amorphous. Note that when the XRD patterns are subjected to the Rietveld analysis, the O3′ type crystal structure preferably accounts for greater than or equal to 50%, further preferably greater than or equal to 60%, still further preferably greater than or equal to 66%. The positive electrode active material in which the O3′ type crystal structure accounts for greater than or equal to 50%, preferably greater than or equal to 60%, further preferably greater than or equal to 66% can achieve sufficiently good cycle performance.

Sharpness of a diffraction peak in an XRD pattern indicates the degree of crystallinity. It is thus preferable that the diffraction peaks after charging be sharp, in other words, have a small half width. Even peaks that are derived from the same crystal phase have different half widths depending on the XRD measurement conditions or the 2θ value. In the case of the above-described measurement conditions, the peak observed at 2θ of greater than or equal to 43° and less than or equal to 46° preferably has a half width of less than or equal to 0.2°, further preferably less than or equal to 0.15°, still further preferably less than or equal to 0.12°. A narrow half width and high crystallinity contribute to stabilization of the crystal structure after charge. By contrast, conventional LiCoO₂ has a small crystallite size and a broad and small peak even when it can have a structure part of which is similar to the O3′ type crystal structure.

### <XPS>

In an inorganic oxide, a region that extends from the surface to a depth approximately 2 nm to 8 nm (usually, equal to or less than 5 nm) can be analyzed by X-ray photoelectron spectroscopy (XPS) using monochromated aluminum Kα radiation as an X-ray; thus, the concentrations of elements in a region extending to approximately half the depth of the surface portion 200a can be quantitatively analyzed. The bonding states of the elements can be analyzed by narrow scanning. Note that in many cases, the quantitative accuracy of XPS is approximately ±1 atomic %, and the lower detection limit is approximately 1 atomic % but depends on the element.

The concentration of the additive element may be compared using the ratio of the additive element to cobalt. The use of the ratio of the additive element to cobalt preferably enables comparison while reducing the influence of a carbonate or the like which is chemically adsorbed after formation of the positive electrode active material. For example, the atomic ratio of magnesium to cobalt (Mg/Co) in the XPS analysis is preferably greater than or equal to 0.400, further preferably greater than or equal to 0.500, still further preferably greater than or equal to 0.600, yet still further preferably greater than or equal to 0.700, yet still further preferably greater than or equal to 0.800, yet still further preferably greater than or equal to 0.900, yet still further preferably greater than or equal to 1.000. The ratio Mg/Co is preferably less than or equal to 2.000, further preferably less than or equal to 1.500, still further preferably less than or equal to 1.400, yet still further preferably less than or equal to 1.300, yet still further preferably less than or equal to 1.200.

For example, the atomic ratio of nickel to cobalt (Ni/Co) in the XPS analysis is preferably greater than or equal to 0.05, further preferably greater than or equal to 0.06, still further preferably greater than or equal to 0.07, yet still further preferably greater than or equal to 0.08, yet still further preferably greater than or equal to 0.09. The ratio Ni/Co is preferably less than or equal to 0.200, further preferably less than or equal to 0.150, still further preferably less than or equal to 0.140, yet still further preferably less than or equal to 0.130, yet still further preferably less than or equal to 0.120, yet still further preferably less than or equal to 0.110.

For example, the atomic ratio of fluorine to cobalt (F/Co) in the XPS analysis is preferably greater than or equal to 0.100, further preferably greater than or equal to 0.200, still further preferably greater than or equal to 0.300, yet still further preferably greater than or equal to 0.400, yet still further preferably greater than or equal to 0.500, yet still further preferably greater than or equal to 0.600, yet still further preferably greater than or equal to 0.700. The ratio F/Co is preferably less than or equal to 1.500, further preferably less than or equal to 1.200, still further preferably less than or equal to 1.100, yet still further preferably less than or equal to 1.000, yet still further preferably less than or equal to 0.900.

When the ratio is within the above range, it can be said that the additive element is not attached to the surface of the positive electrode active material 200 in a narrow range but widely distributed at a preferable concentration in the surface portion 200a of the positive electrode active material 200. That is, when the ratios are within the above ranges in the XPS analysis results of the positive electrode active material 200, the crystal structure is less likely to be broken even when charge that makes x be 0.24 or less and discharge are repeated, so that excellent cycle performance can be achieved.

In addition, when the positive electrode active material 200 of one embodiment of the present invention is analyzed by XPS, a peak indicating the bonding energy of fluorine with another element is preferably at greater than or equal to 682 eV and less than 685 eV, further preferably at approximately 684.3 eV. The above value is different from 685 eV, which is the bonding energy of lithium fluoride, and 686 eV, which is the bonding energy of magnesium fluoride.

Furthermore, when the positive electrode active material 200 of one embodiment of the present invention is analyzed by XPS, a peak indicating the bonding energy of magnesium with another element is preferably at greater than or equal to 1302 eV and less than 1304 eV, further preferably at approximately 1303 eV. The above value is different from 1305 eV, which is the bonding energy of magnesium fluoride, and is close to the bonding energy of magnesium oxide.

### <EDX>

The one or two or more selected from the additive elements contained in the positive electrode active material 200 preferably have a concentration gradient. It is further preferable that the additive elements contained in the positive electrode active material 200 exhibit concentration peaks at different depths from the surface. The concentration gradient of the additive element can be evaluated, for example, by exposing a cross section of the positive electrode active material 200 using FIB (Focused Ion Beam) or the like and analyzing the cross section using EDX (Energy Dispersive X-ray Spectroscopy), EPMA (electron probe microanalysis), or the like.

In the EDX measurement, to measure a region while scanning is performed and evaluate the region two-dimensionally is referred to as EDX area analysis. The measurement for evaluation of the atomic concentration distribution in a positive electrode active material by line scan is referred to as line analysis. Furthermore, extracting data of a linear region from EDX area analysis is referred to as line analysis in some cases. Measurement of a region without scanning is referred to as point analysis.

By EDX area analysis (e.g., element mapping), the concentrations of the additive element in the surface portion 200a, the inner portion 200b, the vicinity of the crystal grain boundary, and the like of the positive electrode active material 200 can be quantitatively analyzed. By EDX line analysis, the concentration distribution and the highest concentration of the additive element can be analyzed. An analysis performed after thinning a sample by FIB or the like is preferred because the analysis makes it possible to analyze the concentration distribution in the depth direction from the surface toward the center in a specific region of the positive electrode active material regardless of the distribution in the front-back direction.

EDX area analysis or EDX point analysis of the positive electrode active material 200 of one embodiment of the present invention preferably can reveal that the concentration of each additive element, in particular, an additive element X in the surface portion 200a is higher than that in the inner portion 200b.

In a STEM-EDX line analysis or the like, it is sometimes difficult to precisely determine the surface because a steep change in a profile of an element is not seen in principle or due to a measurement error. Thus, when referring to the depth direction in STEM-EDX line analysis or the like, a reference point is a point where the value of the amount of the detected transition metal M is equal to 50% of the sum of the average value M_{AVE} of the amount of the detected transition metal M in the inner portion and the average value M_{BG} of the amount of the background transition metal M and a point where a value of the amount of the detected oxygen is equal to 50% of the sum of the average value O_{AVE} of the amount of detected oxygen in the inner portion and the average value O_{BG} of the amount of background oxygen. Note that in the case where the positions of the points differ between the transition metal M and oxygen, the difference is probably due to the influence of a carbonate, a metal oxide containing oxygen, or the like, which is attached to the surface. Thus, the point that is equal to 50% of the sum of the average value M_{AVE} of the amount of the detected transition metal M in the inner portion and the average value M_{BG} of the amount of the background transition metal M can be used. In the case of a positive electrode active material containing a plurality of transition metals M, the reference point can be determined using M_{AVE} and M_{BG} of an element whose count number is the largest in the inner portion 200b.

The average value M_{BG} of the amount of the background cobalt can be calculated by averaging the amount in the range greater than or equal to 2 nm, preferably greater than or equal to 3 nm, which is outside a portion in the vicinity of the portion where the detected amount of cobalt begins to increase, for example. The average value M_{AVE} of the amount in the inner portion can be calculated by averaging the amount in the range greater than or equal to 2 nm, preferably greater than or equal to 3 nm in a region where the count numbers of cobalt and oxygen are saturated and stabilized, e.g., a portion that is greater than or equal to 30 nm, preferably greater than or equal to 50 nm in depth from a region where the detected amount of cobalt begins to increase, for example. The average value O_{BG} of the amount of background oxygen and the average value O_{AVE} of the detected amount of oxygen in the inner portion can be calculated in a similar manner.

The surface of the positive electrode active material 200 in, for example, a cross-sectional STEM (scanning transmission electron microscope) image is a boundary between a region where an image derived from the crystal structure of the positive electrode active material is observed and a region where the image is not observed, and is the outermost surface of a region where an atomic column derived from an atomic nucleus of a metal element that has a greater atomic number than lithium among the metal elements constituting the positive electrode active material is confirmed. Alternatively, the surface refers to an intersection of a tangent drawn at a luminance profile from the surface toward the bulk and an axis in the depth direction in a STEM image. The surface in a STEM image or the like may be judged in combination with analysis with higher spatial resolution.

A peak in STEM-EDX line analysis refers to the maximum value of the detection intensity in each element profile or the maximum value of the characteristic X-ray of each element. As a noise in STEM-EDX line analysis, a measured value having a half width smaller than or equal to spatial resolution (R), for example, smaller than or equal to R/2 can be given.

For example, when EDX area analysis or EDX point analysis of the positive electrode active material 200 containing magnesium as the additive element is conducted, the magnesium concentration in the surface portion 200a is preferably higher than the magnesium concentration in the inner portion 200b. Moreover, in the EDX line analysis, a peak of the concentration of magnesium in the surface portion 200a is preferably observed in a region extending, toward the center of the positive electrode active material 200, from the surface thereof to a depth of 3 nm, further preferably 1 nm, still further preferably 0.5 nm. Alternatively, the peak is preferably observed within ±1 nm from the surface. In addition, the concentration of magnesium preferably attenuates, at a depth of 1 nm from the point where the concentration reaches the peak, to less than or equal to 60% of the peak concentration. In addition, the concentration of magnesium preferably attenuates, at a depth of 2 nm from the point where the concentration reaches the peak, to less than or equal to 30% of the peak concentration. Here, a “peak of concentration” refers to the local maximum value of concentration. Note that due to the influence of spatial resolution in the EDX line analysis, the position where the peak of the magnesium concentration exists sometimes has a negative value as a depth from the surface toward the inner portion.

When the positive electrode active material 200 contains magnesium and fluorine as the additive elements, the distribution of fluorine preferably overlaps with the distribution of magnesium. For example, a difference in the depth direction between a peak of the concentration of fluorine and a peak of the concentration of magnesium is preferably within 10 nm, further preferably within 3 nm, still further preferably within 1 nm.

In the EDX line analysis, a peak of the concentration of fluorine in the surface portion 200a is preferably observed in a region extending, toward the center of the positive electrode active material 200, from the surface thereof to a depth of 3 nm, further preferably 1 nm, still further preferably 0.5 nm. Alternatively, the peak is preferably observed within +1 nm from the surface. It is further preferable that a peak of the concentration of fluorine be exhibited slightly closer to the surface side than a peak of the concentration of magnesium is, which increases resistance to hydrofluoric acid. For example, it is preferable that a peak of the concentration of fluorine be exhibited slightly closer to the surface side than a peak of the concentration of magnesium is by 0.5 nm or more, further preferably 1.5 nm or more.

In the positive electrode active material 200 containing nickel as the additive element, a peak of the concentration of nickel in the surface portion 200a is preferably observed in a region extending, toward the center of the positive electrode active material 200, from the surface thereof to a depth of 3 nm, further preferably 1 nm, still further preferably 0.5 nm. Alternatively, the peak is preferably observed within ±1 nm from the surface. When the positive electrode active material 200 contains magnesium and nickel, the distribution of nickel preferably overlaps with the distribution of magnesium. For example, a difference in the depth direction between a peak of the concentration of nickel and a peak of the concentration of magnesium is preferably within 10 nm, further preferably within 3 nm, still further preferably within 1 nm.

In the case where the positive electrode active material 200 contains aluminum as the additive element, the peak of the concentration of magnesium, the concentration of nickel, or the concentration of fluorine is preferably closer to the surface than the peak of the concentration of aluminum in the surface portion 200a in the EDX line analysis. For example, the peak of the concentration of aluminum is preferably present in a region that is greater than or equal to 0.5 nm and less than or equal to 50 nm in depth, further preferably greater than or equal to 3 nm and less than or equal to 30 nm in depth from the surface toward the center of the positive electrode active material 200.

EDX line, area, or point analysis of the positive electrode active material 200 preferably reveals that the atomic ratio of magnesium to cobalt (Mg/Co) at a peak of the concentration of magnesium is preferably greater than or equal to 0.05 and less than or equal to 0.6, further preferably greater than or equal to 0.1 and less than or equal to 0.4. The atomic ratio of aluminum to cobalt (Al/Co) at a peak of the concentration of aluminum is preferably greater than or equal to 0.01 and less than or equal to 0.6, further preferably greater than or equal to 0.05 and less than or equal to 0.45. The atomic ratio of nickel to cobalt (Ni/Co) at a peak of the concentration of nickel is preferably higher than or equal to 0 and lower than or equal to 0.2, further preferably higher than or equal to 0.01 and lower than or equal to 0.1, still further preferably higher than or equal to 0.05 and lower than or equal to 0.1. The atomic ratio of fluorine to cobalt (F/Co) at a peak of the concentration of fluorine is preferably higher than or equal to 0 and lower than or equal to 1.6, further preferably higher than or equal to 0.1 and lower than or equal to 1.4.

Next, a method for forming the above-described positive electrode active material is described. A way of adding the additive element is important in forming the positive electrode active material 200 having the distribution of an additive element, the composition, and/or the crystal structure described in the above. In the forming process of the positive electrode active material 200, it is preferable that lithium cobalt oxide be synthesized first, and then an additive element source be mixed and heat treatment be performed.

A material functioning as a flux is preferably mixed together with the additive element source. A material with the lower melting point than that of lithium cobalt oxide can function as a flux; therefore, a fluorine compound such as lithium fluoride is preferable for the material. Adding the flux decreases the melting points of the additive element source and the lithium cobalt oxide, which makes it easy to distribute the additive element favorably at a temperature at which the cation mixing is unlikely to occur.

It is further preferable that heat treatment be performed between the synthesis of the lithium cobalt oxide and the mixing of the additive element. This heating is referred to as initial heating in some cases. Owing to influence of lithium extraction from part of the surface portion 200a of the lithium cobalt oxide by the initial heating, the distribution of the additive element becomes more favorable.

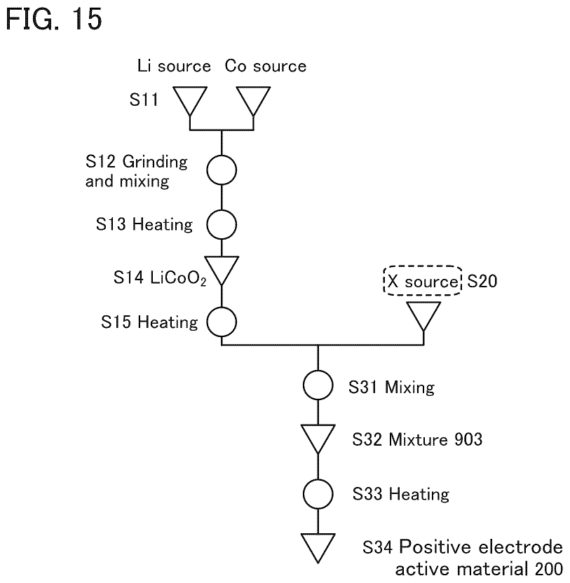

An example of a formation method of the positive electrode active material 200, in which annealing and the initial heating are performed, is described with reference to FIG. 15.

### <<Formation Method of Positive Electrode Active Material>>

### <Step S11>

In Step S11 shown in FIG. 15, a lithium source (Li source) and a cobalt source (Co source) are prepared as materials for lithium and cobalt which are starting materials.

As the lithium source, a lithium-containing compound such as lithium carbonate, lithium hydroxide, lithium nitrate, or lithium fluoride is preferably used, and as the cobalt source, a compound containing cobalt is preferably used, and for example, cobalt oxide, cobalt hydroxide, or the like can be used.

### <Step S12>

Next, the lithium source and the cobalt source are ground and mixed to form a mixed material (Step S12). The grinding and mixing can be performed by a dry method or a wet method. An aprotic solvent is preferably used as the solvent in the case of a wet method. A ball mill, a bead mill, or the like can be used for the grinding and mixing.

### <Step S13>

Next, the above mixed material is heated (Step S13). The heating is preferably performed at higher than or equal to 800° C. and lower than or equal to 1100° C. The heating time is preferably longer than or equal to 1 hour and shorter than or equal to 100 hours, and the temperature rising rate is preferably higher than or equal to 80° C./h and lower than or equal to 250° C./h. The heating is preferably performed in an oxygen-containing atmosphere with a small amount of water such as dry air.

### <Step S14>

Through the above steps, lithium cobalt oxide (LiCoO₂) can be obtained (Step S14).

### <Step S15>

Next, the above composite oxide is heated (Step S15). This step is the first heating performed on lithium cobalt oxide and thus, the heating in Step S15 is referred to as the initial heating. Through the initial heating, an effect of smoothing the surface of lithium cobalt oxide is obtained. It is found that performing the initial heating can reduce degradation after charging and discharging.

In a secondary battery including lithium cobalt oxide with a smooth surface as a positive electrode active material, deterioration by charge and discharge is suppressed and a crack in the positive electrode active material can be prevented. In addition, when a short circuit as in a nail penetration test occurs, combustion due to thermal runaway can be inhibited.

### <Step S20>

The additive element X may be added to lithium cobalt oxide with a smooth surface as long as a layered rock-salt crystal structure can be obtained (Step S20). When the added element X is added to lithium cobalt oxide with a smooth surface, the added element can be uniformly added. As the additive element X, one or more elements selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, bromine, and beryllium can be used. Note that as the additive element X, magnesium and fluorine are preferable, and lithium fluoride and magnesium fluoride are preferably used as the fluorine source and the magnesium source, respectively. When the additive element X is ground and heated as performed in S12 and S13, the additive element source (X source) can be formed.

The particle diameter of the additive element source preferably has a median diameter (D50) of greater than or equal to 600 nm and less than or equal to 20 μm because the mixture is easily attached to the surface portion of the composite oxide particle uniformly. When fluorine and magnesium are contained in the surface portion, the O3′ type crystal structure and the O3″ type crystal structure are easily obtained in a charged state.

### <Step S31>

Next, lithium cobalt oxide and the additive element source (X source) are mixed (Step S31). The ratio of the number Co of the transition metal atoms in the composite oxide containing lithium, the transition metal, and oxygen to the number Mg of magnesium atoms contained in the X source is preferably Co: Mg=100:y (0.1≤y≤6).

### <Step S32>

Next, the materials mixed in the above step are collected to obtain a mixture 903 (Step S32).

### <Step S33>

Next, the mixture 903 is heated (Step S33). Any of the heating conditions described for Step S13 can be selected to perform the heating. The heating temperature is preferably higher than or equal to 500° C. and lower than or equal to 1130° C. and the heating time is preferably longer than or equal to 2 hours.

### <Step S34>

Next, the heated material is collected and then crushed as needed to obtain the positive electrode active material 200 (Step S34). Here, the collected particles are preferably made to pass through a sieve. Through the above steps, the positive electrode active material 200 can be formed.

When a secondary battery is fabricated using the positive electrode formed using the above-described positive electrode material and the negative electrode described above, a lithium-ion secondary battery with excellent charge and discharge capacity and charge and discharge cycle performance and a high level of safety or reliability can be obtained.

The positive electrode includes a positive electrode active material layer and a positive electrode current collector. The positive electrode active material layer includes the positive electrode active material 200 described above, and may include a conductive material (also referred to as a conductive additive) and a binder.

As the conductive material, a carbon-based material such as acetylene black can be used. In addition, carbon nanotube, graphene, or a graphene compound can be used as the conductive material.

As the binder, for example, a cellulose derivative such as styrene-butadiene rubber (SBR), styrene-isoprene-styrene rubber, acrylonitrile-butadiene rubber, butadiene rubber, ethylene-propylene-diene copolymer, fluorine rubber, carboxymethyl cellulose (CMC), methyl cellulose, ethyl cellulose, hydroxypropyl cellulose, diacetyl cellulose, or regenerated cellulose, starch, polystyrene, polyglutamic acid, methyl polyacrylate, poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, nitrocellulose, or the like is preferably used. A plurality of the above-described materials may be used in combination for the binder.

The current collector can be formed using a material that has high conductivity, such as a metal like stainless steel, gold, platinum, aluminum, or titanium, or an alloy thereof. It is preferable that a material used for the positive electrode current collector not be eluted at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Electrolyte Solution]

The electrolyte solution includes a solvent and an electrolyte. The use of an ionic liquid (also referred to as a normal temperature molten salt) that are unlikely to burn and volatize is preferable. The use of one or more of such ionic liquids can prevent a secondary battery from exploding and/or catching fire even when the internal temperature increases owing to an internal short circuit, overcharge, or the like of the secondary battery. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As a solvent of the electrolytic solution, an aprotic organic solvent can be used. As the aprotic organic solvent, for example, one of ethylene carbonate (EC), propylene carbonate (PC), butylene carbonate, chloroethylene carbonate, vinylene carbonate, γ-butyrolactone, Y-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, a mixed solvent of a fluorinated cyclic carbonate (also referred to as a cyclic carbonate fluoride in some cases) and a fluorinated chain carbonate (also referred to as a chain carbonate fluoride in some cases) may be used. As a fluorinated cyclic carbonate, fluoroethylene carbonate (FEC, or F1EC), difluoroethylene carbonate (DFEC or F2EC), trifluoroethylene carbonate (F3EC), or tetrafluoroethylene carbonate (F4EC) or the like can be used. Note that DFEC has isomers such as a cis-4,5 isomer and a trans-4,5 isomer. Each of these fluorinated cyclic carbonates includes a substituent with an electron-withdrawing property and is thus presumed to have a low solvation energy of a lithium ion. Examples of the fluorinated chain carbonate include methyl 3,3,3-trifluoropropionate, trifluoromethyl 3,3,3-trifluoropropionate, and trifluoromethyl propionate, and methyl 2,2-difluoropropionate.

The fluorinated chain carbonate has an effect of lowering or maintaining the viscosity of the electrolyte solution. Therefore, a lithium-ion secondary battery that can be charged and discharged in a low-temperature environment can be provided as long as the mixed solvent contains the fluorinated cyclic carbonate and the fluorinated chain carbonate.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination at an appropriate ratio.

Furthermore, an additive agent such as vinylene carbonate, propane sultone (PS), tert-butylbenzene (TBB), fluoroethylene carbonate (FEC), lithium bis(oxalate) borate (LiBOB), or a dinitrile compound such as succinonitrile or adiponitrile may be added to the electrolyte solution. The concentration of the material to be added in the whole solvent is, for example, higher than or equal to 0.1 wt % and lower than or equal to 5 wt %. It is particularly preferable to use VC or LiBOB because it facilitates formation of a favorable coating portion.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, a solid electrolyte including a polymer material such as a PEO (polyethylene oxide)-based high molecular material, or the like can be used. When the solid electrolyte is used, a separator and/or a spacer is not necessary. Furthermore, the battery can be entirely solidified; therefore, there is no possibility of liquid leakage and thus the safety of the battery is dramatically improved.

### [Separator]

The secondary battery preferably includes the separator. The separator can be formed using, for example, paper, nonwoven fabric, glass fiber, ceramics, or synthetic fiber containing nylon (polyamide), vinylon (polyvinyl alcohol-based fiber), polyester resin, acrylic resin, polyolefin resin, or polyurethane resin. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon, aramid (meta-based aramid and para-based aramid), and polyimide.

When the separator is coated with the ceramic-based material, the oxidation resistance is improved; hence, degradation of the separator during high-voltage charging and discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is in contact with the positive electrode may be coated with the mixed material of aluminum oxide and aramid, and a surface of the polypropylene film that is in contact with the negative electrode may be coated with the fluorine-based material.

The use of a separator having a multilayer structure makes it possible to maintain the safety of the secondary battery even when the total thickness of the separator is small, so that the discharge capacity per volume of the secondary battery can be increased.

### [Exterior Body]

For the exterior body included in the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

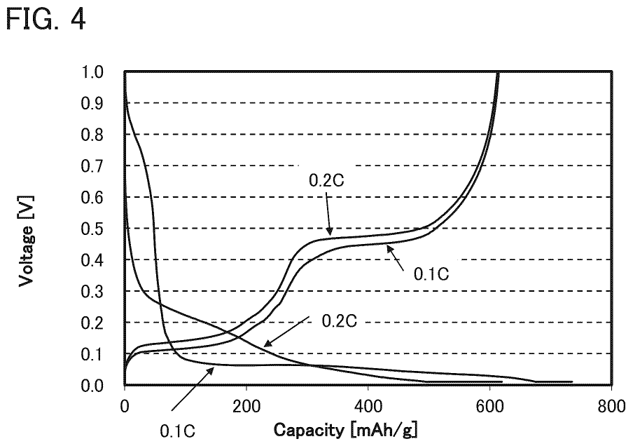

Here, a half cell (Sample 1) using polyglutamic acid as a binder was fabricated, and the results of the cycle performance are described. FIG. 4 shows the results of the cycle performance (curves of charge and discharge characteristics).

In Sample 1, the weight ratio of silicon particles to graphite particles to polyglutamic acid to acetylene black was 8:72:14:6. As the silicon particles, silicon particles (product number 633097 manufactured by Sigma-Aldrich Co. LLC) each of which has a specific surface area of 12.7715 m²/g by a BET method and a particle diameter of 100 nm were used. As the graphite particles, graphite (FormulaBT 1520 manufactured by Superior Graphite Co.) having an average particle diameter of 20 μm was used. As the binder, polyglutamic acid (manufactured by Nippon Poly-Glu Co., Ltd.) was used. Polyglutamic acid (also referred to as PGA) was used without neutralization.

A negative electrode is formed in such a manner that the graphite particles, the silicon particles, the binder, and the acetylene black are mixed at predetermined amounts, deionized water is added to the mixture to form slurry, the slurry is applied over a current collector (copper foil) and dried, and pressing is performed. Polyglutamic acid is a polar polymer and has hydrophilicity, and thus can be dissolved in deionized water.

Sample 1, which was the half cell using the negative electrode formed in such a manner that the powders were mixed, deionized water was added to form a slurry, and the slurry was applied over the current collector, was prepared. Note that heating was sufficiently performed after the application to evaporate a solvent component (moisture). The carried amount of the negative electrode was adjusted to be greater than or equal to 3.8 mg/cm² and less than or equal to 4.2 mg/cm².

With a positive electrode can and a negative electrode can formed of stainless steel (SUS) and a lithium metal prepared for a counter electrode, a coin-type half cell including the above-described negative electrode structure was fabricated. Note that PP (porous polypropylene) was used for a separator, and EMI-FSI (1-ethyl-3-methylimidazolium bis(fluorosulfonyl)imide) in which 2.15M LiFSI was dissolved was used for a electrolyte as an ionic liquid. EMI, which is a cation of the ionic liquid, does not contain fluorine at a terminal. The concentration of the lithium salt in the electrolyte solution was 2.15 mol/L.

As shown in FIG. 4, the half cell used as the negative electrode, at room temperature, was discharged from 1 V to 0.01 V at a predetermined current at a discharge rate of 0.1 C, and when the voltage reached 0.01 V, discharge was performed at a constant voltage (first discharge). After that, the half cell was charged to 1 V at a first charge rate of 0.1 C (first charge). The first discharge and the first charge are collectively regarded as one cycle. One-hour break was taken after that, and second discharge was performed as following; charging was performed at a discharge rate of 0.2 C and then discharge was performed at a predetermined current. After that, second charge was performed to 1 V at a charge rate of 0.2 C.

FIG. 4 shows only charging and discharging in the first charge (0.1 C) and charging and discharging in the second charge (0.2 C). That is, two cycles of the charge and discharge test of Sample 1 are shown. The first charge amount of Sample 1 was 614.7 mAh/g. Note that the theoretical capacity of graphite is 372 mAh/g, and it is confirmed that mixing nanosilicon increases the capacity.

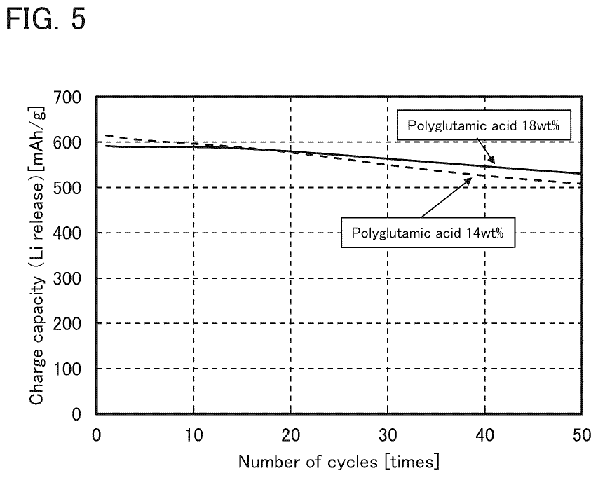

Next, FIG. 5 shows results of 50 cycles of the cycle test on Sample 1. One-hour break was taken between the first cycle and the second cycle. Ten-minute break was taken between the second cycle and the third cycle. Ten-minute break was taken between cycles after the third cycle. Furthermore, the cycle test was performed at a charge rate of 0.2 C and a discharge rate of 0.2 C after the third cycle.

FIG. 5 shows the cycle performance of Sample 2 having a structure similar to that of Sample 1 except that the polyglutamic acid is 18 wt %. The measurement was performed in a manner similar to that of Sample 1. In Sample 2, the weight ratio of silicon particles, graphite particles, polyglutamic acid, and acetylene black is 7.6:68.4:18:6. The first charge amount of Sample 2 was 591.7 mAh/g. The result shows that Sample 1 has a higher first charge amount than Sample 2, but Sample 2 has a more preferable cycle retention rate than Sample 1.

As shown in FIG. 5, even when the proportion of polyglutamic acid that is a binder is increased, the capacity is not decreased and a significant improvement in characteristics can be confirmed.

### Embodiment 2

In this embodiment, an example of a shape of a secondary battery including the positive electrode and the negative electrode described in Embodiment 1 is described.

### [Coin-Type Secondary Battery]

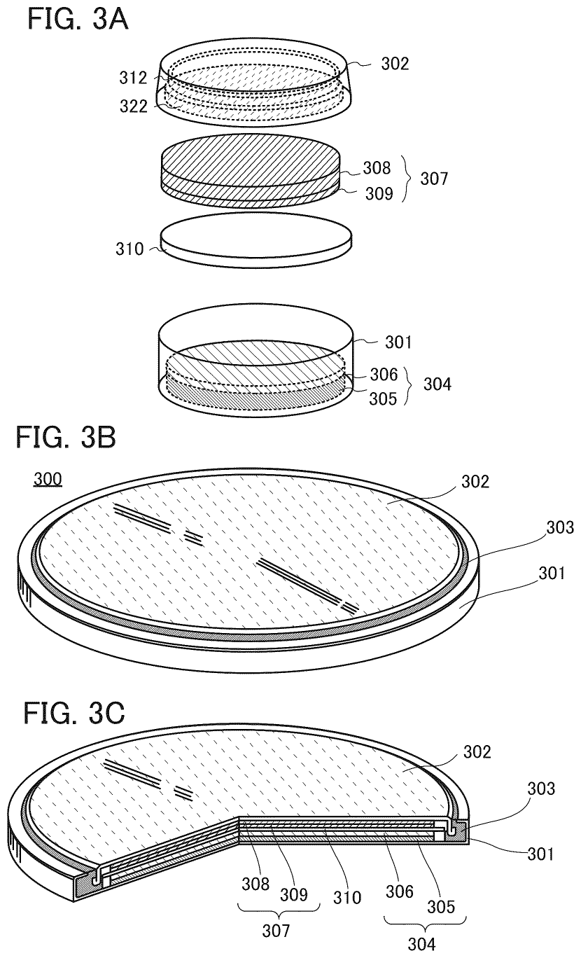

An example of a coin-type secondary battery is described. FIG. 3A is an exploded perspective view of a coin-type (single-layer flat type) secondary battery, FIG. 3B is an external view thereof, and FIG. 3C is a cross-sectional view thereof. Coin-type secondary batteries are mainly used in small electronic devices.

For easy understanding, FIG. 3A is a schematic view showing overlap (a vertical relation and a positional relation) between components. Thus, FIG. 3A and FIG. 3B do not completely correspond with each other.

In FIG. 3A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 3A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

FIG. 3B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel or aluminum in order to prevent corrosion due to the electrolyte solution, for example. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in the electrolyte solution or an ionic liquid; as illustrated in FIG. 3C, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

The separator 310 can be formed using, for example, a fiber containing cellulose, such as paper, nonwoven fabric, glass fiber, ceramics, or synthetic fiber using nylon resin (polyamide), vinylon resin (polyvinyl alcohol-based fiber), polyester resin, acrylic resin, polyolefin resin, or polyurethane resin.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator during high-voltage charging and discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is in contact with the positive electrode may be coated with the mixed material of aluminum oxide and aramid, and a surface of the polypropylene film that is in contact with the negative electrode may be coated with the fluorine-based material.

The use of a separator having a multilayer structure makes it possible to maintain the safety of the secondary battery even when the total thickness of the separator is small, so that the capacity per volume of the secondary battery can be increased.

When the negative electrode 307 and the positive electrode 304 each having the structure described in Embodiment 1 are used for the above coin-type secondary battery 300, the coin-type secondary battery 300 can have excellent cycle performance and a high level of safety and reliability.

### Embodiment 3

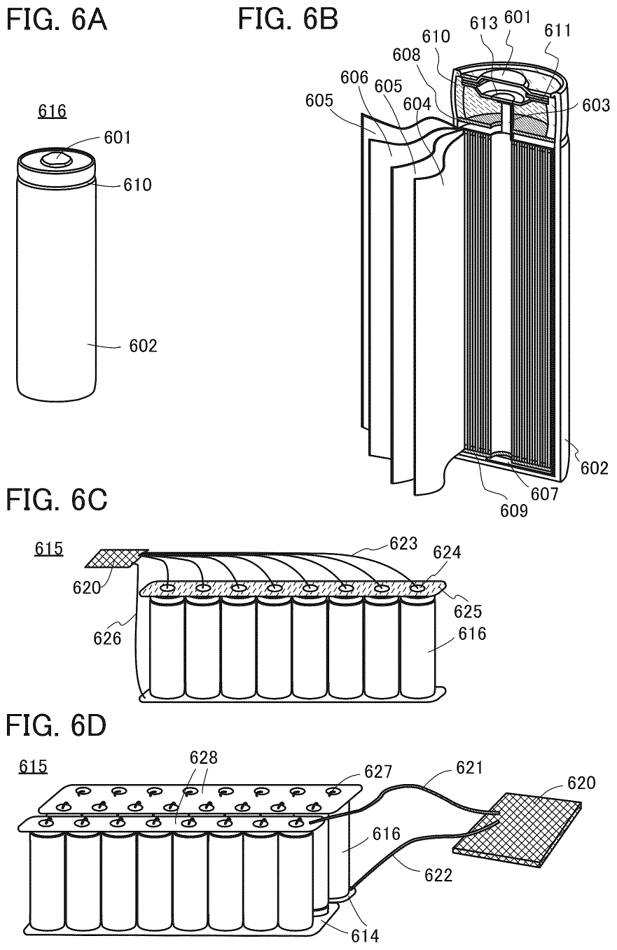

An example of a cylindrical secondary battery is described with reference to FIG. 6A. As illustrated in FIG. 6A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 6B schematically illustrates a cross section of a cylindrical secondary battery. The cylindrical secondary battery illustrated in FIG. 6B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a secondary battery in which a belt-like positive electrode 604 and a belt-like negative electrode 606 are wound with a belt-like separator 605 located therebetween is provided. Although not illustrated, the secondary battery is wound around a central axis. One end of the battery can 602 is closed and the other end thereof is open. For the battery can 602, a metal having corrosion resistance to an electrolyte solution, such as nickel, aluminum, or titanium, an alloy of such a metal, and an alloy of such a metal and another metal (e.g., stainless steel) can be used. The battery can 602 is preferably covered with nickel and aluminum in order to prevent corrosion due to the electrolyte solution. Inside the battery can 602, the secondary battery in which the positive electrode, the negative electrode, and the separator are wound is provided between a pair of insulating plates 608 and 609 that face each other. A nonaqueous electrolyte solution (not illustrated) is injected inside the battery can 602 provided with the secondary battery. A nonaqueous electrolyte solution similar to that for the coin-type secondary battery can be used.

Since a positive electrode and a negative electrode that are used for a cylindrical storage battery are wound, active materials are preferably formed on both surfaces of a current collector.

When the negative electrode 606 and the positive electrode 604 each having the structure described in Embodiment 1 are used for the above cylindrical secondary battery 616, the cylindrical secondary battery 616 can have excellent cycle performance and a high level of safety and reliability.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic can be used for the PTC element.

FIG. 6C illustrates an example of a power storage system 615. The power storage system 615 includes a plurality of the secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charging and discharging control circuit or a protection circuit for preventing overcharge and/or overdischarge can be used.

FIG. 6D illustrates an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 6D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

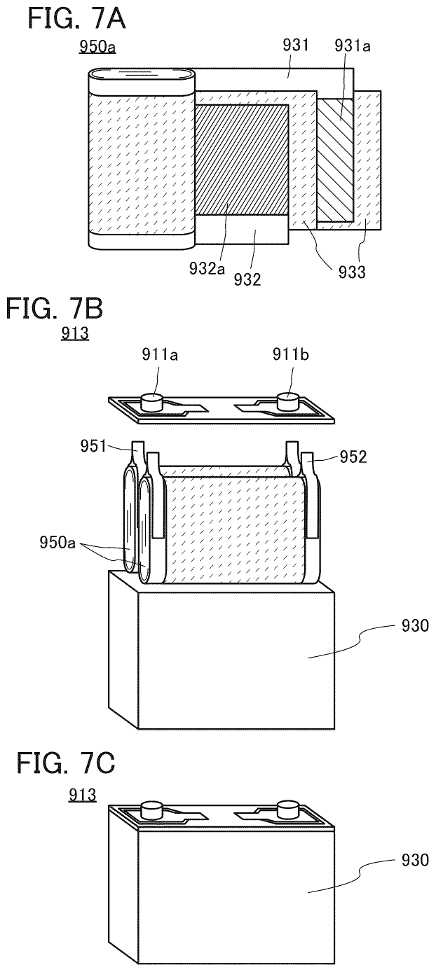

Structure examples of secondary batteries are described with reference to FIG. 7.

A secondary battery 913 may include a wound body 950a as illustrated in FIG. 7A. The wound body 950a illustrated in FIG. 7A includes a negative electrode 931, a positive electrode 932, and separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

When the negative electrode 931 and the positive electrode 932 each having the structure described in Embodiment 1 are used for the above secondary battery 913, the secondary battery 913 can have excellent cycle performance and a high level of safety and reliability.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 7B, the negative electrode 931 is electrically connected to a terminal 951 by ultrasonic bonding, welding, or pressure bonding. The terminal 951 is electrically connected to a terminal 911a. The positive electrode 932 is electrically connected to a terminal 952 by ultrasonic bonding, welding, or pressure bonding. The terminal 952 is electrically connected to a terminal 911b.

As illustrated in FIG. 7C, the wound body 950a and an electrolyte solution are covered with a housing 930, whereby the secondary battery 913 is completed. The housing 930 is preferably provided with a safety valve, an overcurrent protection element, and the like. For the housing 930, a metal material (e.g., aluminum) or a resin material can be used. In order to prevent the battery from exploding, a safety valve is a valve to be released when the internal pressure of the housing 930 reaches a predetermined pressure.

As illustrated in FIG. 7B, the secondary battery 913 may include a plurality of wound bodies 950a. The use of the plurality of wound bodies 950a enables the secondary battery 913 to have higher charge and discharge capacity.

### <Laminated Secondary Battery>

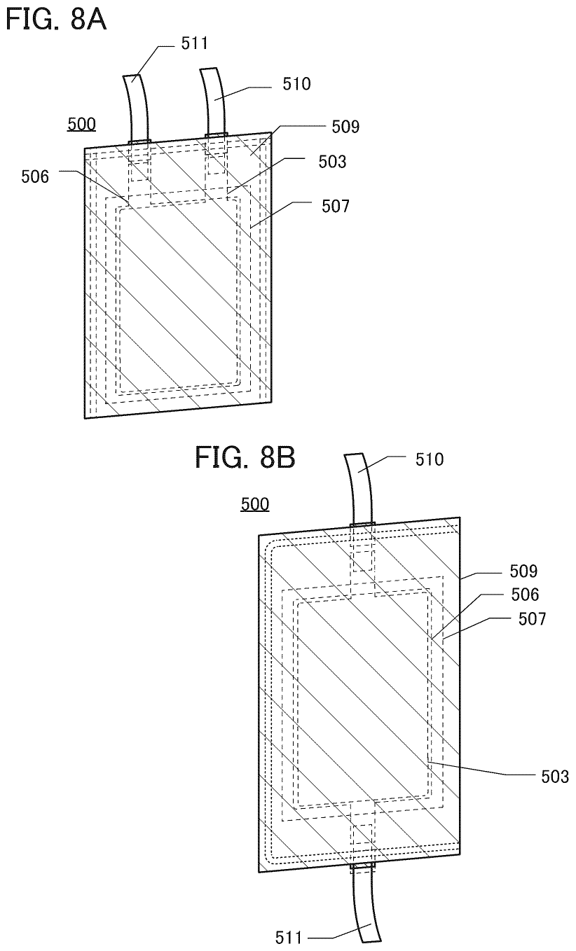

Next, examples of the appearance of a laminated secondary battery are illustrated in FIG. 8A and FIG. 8B. In FIG. 8A and FIG. 8B, a positive electrode 503, a negative electrode 506, a separator 507, an exterior body 509, a positive electrode lead electrode 510, and a negative electrode lead electrode 511 are included.

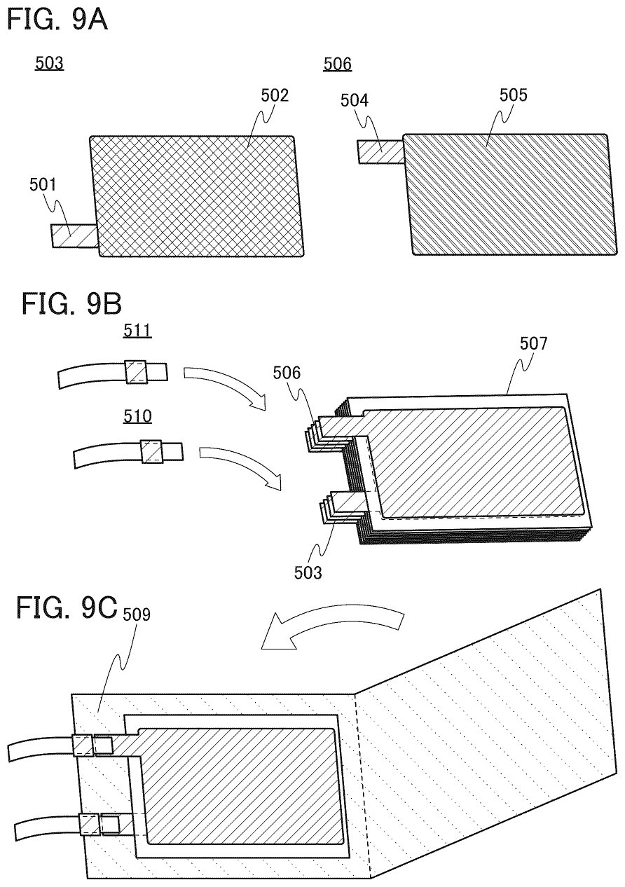

FIG. 9A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. Note that the areas or the shapes of the tab regions included in the positive electrode and the negative electrode are not limited to the examples illustrated in FIG. 9A.

### <Fabrication Method of Laminated Secondary Battery>

Here, an example of a method for fabricating the laminated secondary battery whose external view is illustrated in FIG. 8A is described with reference to FIG. 9B and FIG. 9C.

First, the negative electrode 506, the separator 507, and the positive electrode 503 are stacked. FIG. 9B illustrates the negative electrodes 506, the separators 507, and the positive electrodes 503 which are stacked. Here, an example in which five negative electrodes and four positive electrodes are used is shown. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 9C. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, a laminated secondary battery 500 can be fabricated.

When the negative electrode 506 and the positive electrode 503 each having the structure described in Embodiment 1 are used for the above secondary battery 500, the secondary battery 500 can have excellent cycle performance and a high level of safety and reliability.

### Embodiment 4

Next, examples in which the secondary battery including the negative electrode of one embodiment of the present invention is mounted on a vehicle, typically a transport vehicle, will be described.

Mounting the plurality of secondary batteries illustrated in any one of FIG. 6A, FIG. 7C, FIG. 8A, and FIG. 8B on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be a secondary battery with high capacity. Thus, the lithium-ion secondary battery of one embodiment of the present invention is suitable for reduction in size and weight, has excellent safety and reliability, and can be suitably used in transport vehicles.

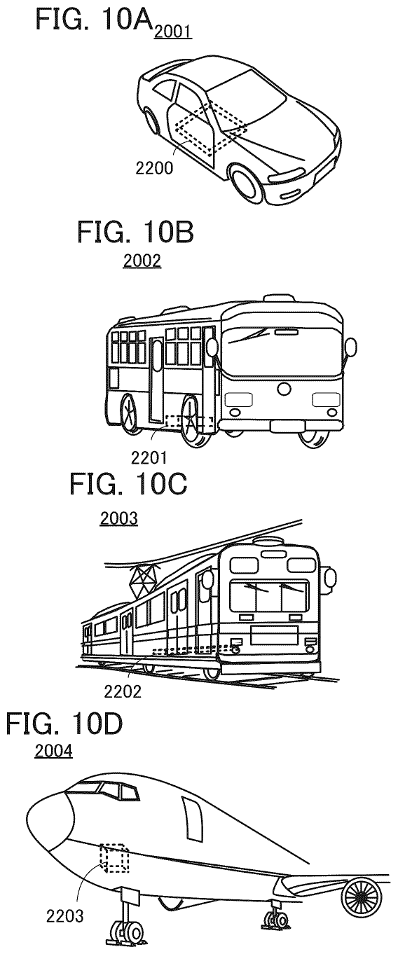

FIG. 10A to FIG. 10D illustrate examples of transport vehicles using one embodiment of the present invention. An automobile 2001 illustrated in FIG. 10A is an electric vehicle that runs using an electric motor as a driving power source. Alternatively, the automobile 2001 is a hybrid vehicle that can appropriately select an electric motor or an engine as a driving power source. In the case where the secondary battery is mounted on the vehicle, an example of the secondary battery described in Embodiment 3 is provided at one position or several positions. The automobile 2001 illustrated in FIG. 10A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power from external charging equipment by a plug-in system, a contactless power feeding system, or the like. In charge, a given method such as CHAdeMO (registered trademark) or Combined Charging System may be employed as a charge method, the standard of a connector, and the like as appropriate. Charge equipment may be a charge station provided in a commerce facility or a household power supply. For example, with the use of the plug-in system, the power storage device mounted on the automobile 2001 can be charged by being supplied with electric power from the outside. Charge can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 10B illustrates a large transporter 2002 having a motor controlled by electricity as an example of a transport vehicle. A secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has the same function as that in FIG. 10A except, for example, the number of secondary batteries configuring the secondary battery module; thus, the description is omitted.

FIG. 10C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. When a secondary battery including the positive electrode and the negative electrode described in Embodiment 1 is used, a secondary battery having favorable rate performance, charge and discharge cycle performance, and a high level of safety and reliability can be manufactured, which can contribute to higher performance and a longer lifetime of the transport vehicle 2003. A battery pack 2202 has the same function as that in FIG. 10A except, for example, the number of secondary batteries configuring the secondary battery module; thus, the description is omitted.

FIG. 10D illustrates an aircraft 2004 having a combustion engine as an example. The aircraft 2004 illustrated in FIG. 10D is regarded as a kind of transport vehicles because it has wheels for takeoff and landing, and includes a battery pack 2203 that includes a charge control device and a secondary battery module configured by connecting a plurality of secondary batteries.

The secondary battery module of the aircraft 2004 has eight 4 V secondary batteries connected in series, which has the maximum voltage of 32 V, for example. The battery pack 2203 has the same function as that in FIG. 10A except, for example, the number of secondary batteries configuring the secondary battery module; thus, the description is omitted.

The contents of this embodiment can be combined with the contents of the other embodiments as appropriate.

### Embodiment 5

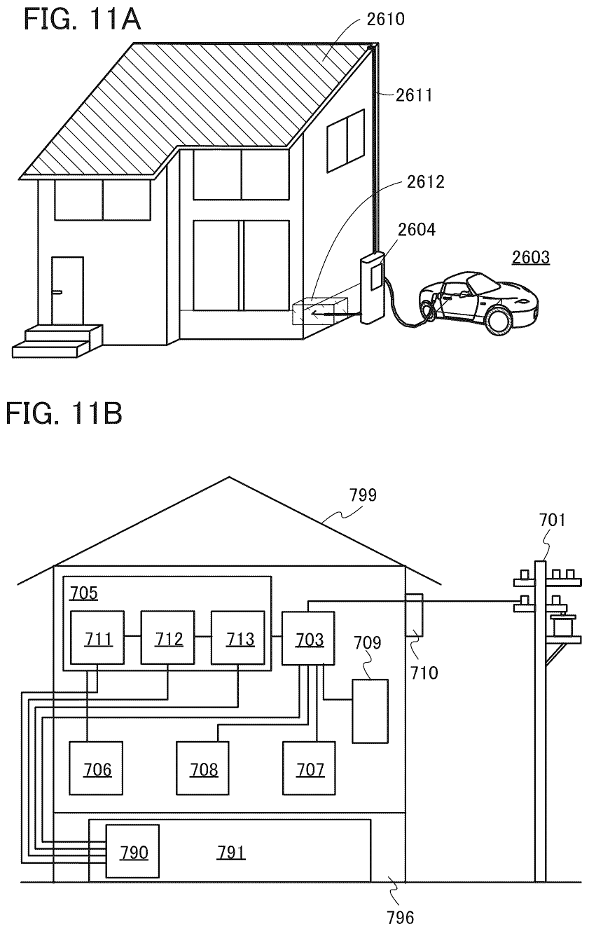

In this embodiment, examples in which the secondary battery of one embodiment of the present invention is mounted on a building will be described with reference to FIG. 11A and FIG. 11B.

A house illustrated in FIG. 11A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to ground-based charge apparatus 2604. The power storage device 2612 can be charged with electric power generated by the solar panel 2610. A secondary battery included in a vehicle 2603 can be charged with the electric power stored in the power storage device 2612 through the charge apparatus 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure.

FIG. 11B illustrates an example of a power storage device of one embodiment of the present invention. As illustrated in FIG. 11B, a power storage device 791 of one embodiment of the present invention is provided in an underfloor space 796 of a building 799. When a secondary battery including the negative electrode and the positive electrode described in Embodiment 1 is used for the power storage device 791, the power storage device 791 can have high discharge capacity.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

The contents of this embodiment can be combined with the contents of the other embodiments as appropriate.

### Embodiment 6

In this embodiment, examples in which a motorcycle and a bicycle are each provided with the power storage device of one embodiment of the present invention will be described.

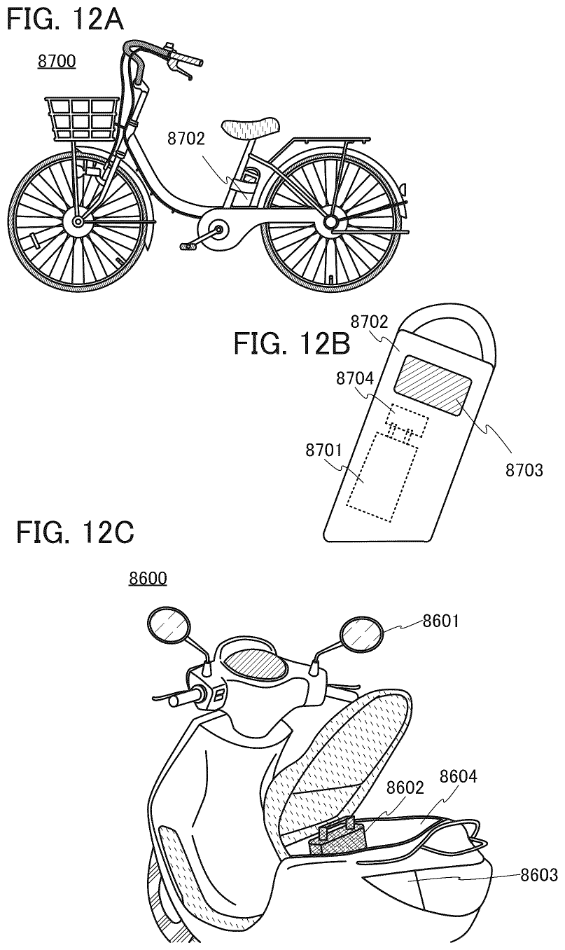

FIG. 12A illustrates an example of an electric bicycle using the power storage device of one embodiment of the present invention. The power storage device of one embodiment of the present invention can be used for an electric bicycle 8700 illustrated in FIG. 12A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 12B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 6. The control circuit 8704 is electrically connected to a positive electrode and a negative electrode of the storage battery 8701. The control circuit 8704 may be provided with the small solid-state secondary battery illustrated in FIG. 8A and FIG. 8B. When the small solid-state secondary battery illustrated in FIG. 8A and FIG. 8B is provided in the control circuit 8704, electric power can be supplied to store data in a memory circuit included in the control circuit 8704 for a long time. When the control circuit 8704 is used in combination with a secondary battery including the positive electrode and the negative electrode described in Embodiment 1, the synergy on safety can be obtained.

FIG. 12C illustrates an example of a motorcycle using the power storage device of one embodiment of the present invention. A motor scooter 8600 illustrated in FIG. 12C includes a power storage device 8602, side mirrors 8601, and indicator lights 8603. The power storage device 8602 can supply electricity to the indicator lights 8603. The power storage device 8602 including a plurality of secondary batteries including the positive electrode and the negative electrode described in Embodiment 1 can have high capacity and contribute to a reduction in size.

In the motor scooter 8600 illustrated in FIG. 12C, the power storage device 8602 can be stored in an under-seat storage unit 8604. The power storage device 8602 can be stored in the under-seat storage unit 8604 even with a small size.

The contents of this embodiment can be combined with the contents of the other embodiments as appropriate.

### Embodiment 7

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

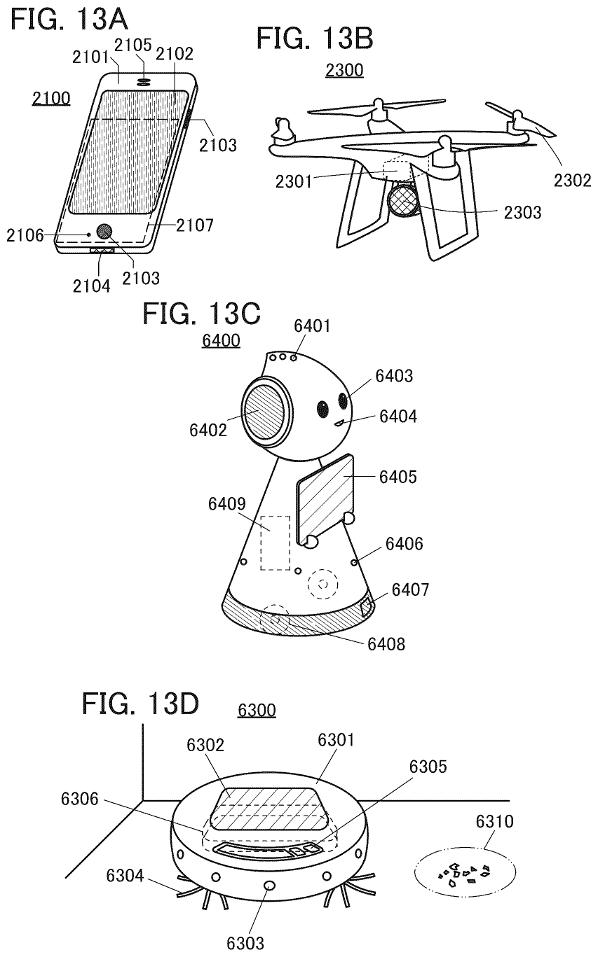

FIG. 13A illustrates an example of a mobile phone. A mobile phone 2100 includes a housing 2101 in which a display portion 2102 is incorporated, operation buttons 2103, an external connection port 2104, a speaker 2105, a microphone 2106, and the like. The mobile phone 2100 includes a secondary battery 2107. The use of the secondary battery 2107 including the negative electrode and the positive electrode described in Embodiment 1 achieves a high level of safety and reliability and high capacity, and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 13B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including the negative electrode and the positive electrode described in Embodiment 1 has excellent cycle performance and a high level of safety, and thus can be used safely for a long time over a long period and is preferable as the secondary battery included in the unmanned aircraft 2300.

FIG. 13C illustrates an example of a robot. A robot 6400 illustrated in FIG. 13C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including the negative electrode and the positive electrode described in Embodiment 1 has excellent cycle performance and a high level of safety, and thus can be used safely for a long time over a long period and is preferable as the secondary battery 6409 included in the robot 6400.

FIG. 13D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including the negative electrode and the positive electrode described in Embodiment 1 has excellent cycle performance and a high level of safety, and thus can be used safely for a long time over a long period of time and is preferable as the secondary battery 6306 included in the cleaning robot 6300.

The contents of this embodiment can be combined with the contents of the other embodiments as appropriate.

### Embodiment 8

In this embodiment, thermal runaway, a nail penetration test, and the like of a secondary battery will be explained and the principle or the like that ignition is less likely to occur when a secondary battery including a positive electrode using the positive electrode active material 200 is subjected to a nail penetration test will be described.

### <Thermal Runaway of Secondary Battery>

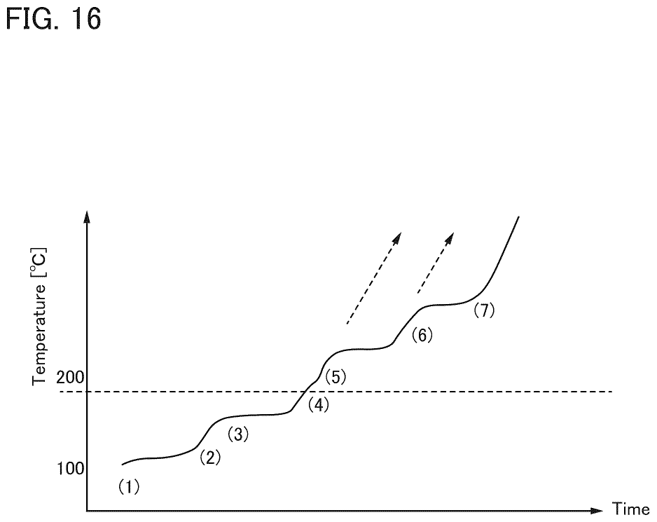

FIG. 16 shows a graph obtained by partly modifying the graph cited from [FIG. 1-11] on (hereinafter simply referred to as temperature) of a secondary battery with respect to time. According to the graph, when the temperature rises, the secondary battery enters thermal runaway after passing through several states.

In general, when the temperature of the secondary battery reaches 100° C. and the vicinity thereof, (1) collapse of the negative electrode and heat generation are caused. When the temperature of the secondary battery exceeds 100° C., (2) reduction of an electrolyte solution by the negative electrode (the negative electrode is C₆Li when graphite is used) and heat generation are caused, and (3) oxidation of the electrolyte solution by a positive electrode and heat generation are caused. When the temperature of the secondary battery reaches 180° C. or the vicinity thereof, (4) thermal decomposition of the electrolyte solution is caused and (5) oxygen release from the positive electrode and thermal decomposition of the positive electrode (the thermal decomposition includes a structural change in a positive electrode active material) are caused. After that, when the temperature of the secondary battery exceeds 200° C., (6) decomposition of the negative electrode is caused, and finally, (7) the positive electrode and the negative electrode come into direct contact with each other. The secondary battery enters thermal runaway after passing through the state (5), the state (6), the state (7), or the like. Thus, to prevent thermal runaway, the temperature rise of the secondary battery is preferably inhibited and the negative electrode, the positive electrode, and/or the electrolyte solution is/are preferably kept stable at high temperatures exceeding 100° C.

The positive electrode active material 200 described in Embodiment 1 above has a stable crystal structure and an effect of inhibiting release of oxygen. Thus, the secondary battery using the positive electrode active material 200 probably does not come into a state after at least the state (5) and the temperature rise of the secondary battery is probably inhibited, leading to a significant effect that thermal runaway is less likely to occur.

### <Nail Penetration Test>

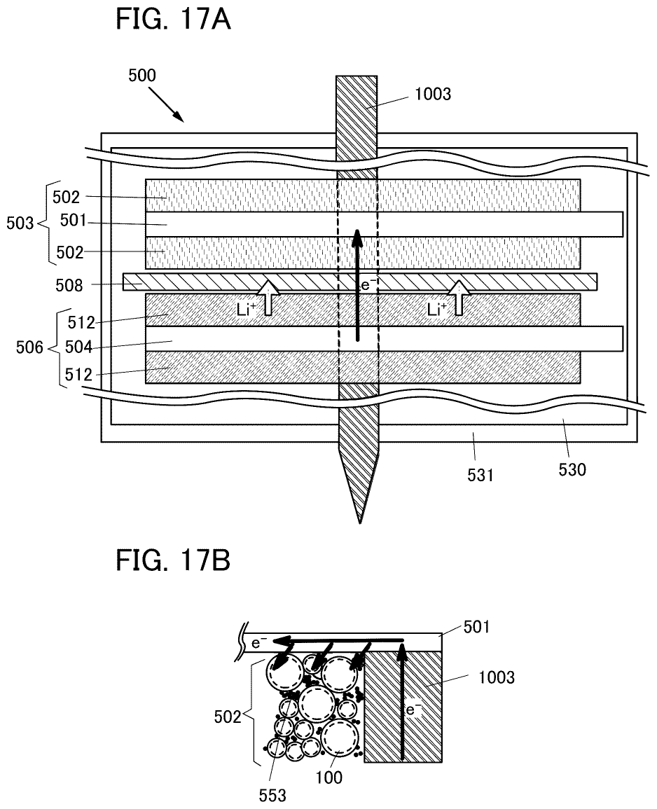

Next, a nail penetration test is described with reference to FIG. 17A and FIG. 17B and the like. In the nail penetration test, a nail 1003 having a predetermined diameter selected from a range of 2 mm to 10 mm penetrates the secondary battery 500 in a fully charged state (a state at 100% state of charge (SOC)) at a predetermined speed selected from a range of 1 mm/s to 20 mm/s, for example. FIG. 17A is a cross-sectional view illustrating a state where the nail 1003 penetrates the secondary battery 500. The secondary battery 500 has a structure in which the positive electrode 503, a separator 508, the negative electrode 506, and an electrolyte solution 530 are held in an exterior body 531. The positive electrode 503 includes the positive electrode current collector 501 and the positive electrode active material layers 502 formed over both surfaces of the positive electrode current collector 501. The negative electrode 506 includes the negative electrode current collector 504 and negative electrode active material layers 512 formed over both surfaces of the negative electrode current collector 504. FIG. 17B is an enlarged view of the nail 1003 and the positive electrode current collector 501 and clearly shows the positive electrode active material 200 of one embodiment of the present invention and a conductive material 553 which are included in the positive electrode active material layer 502.

In general, as illustrated in FIG. 17A and FIG. 17B, when the nail 1003 penetrates the positive electrode 503 and the negative electrode 506, an internal short circuit occurs. This makes the potential of the nail 1003 equal to that of the negative electrode, so that an electron (e⁻) flows to the positive electrode 503 through the nail 1003 and the like as indicated by the arrow and Joule heat is generated in the portion where the internal short circuit occurs and the vicinity thereof. The internal short circuit causes carrier ions, typically lithium ions (Li⁺), to be extracted from the negative electrode 506 and to be released into the electrolyte solution as indicated by white arrows. At this time, insufficient anions in the electrolyte solution 530 causes the electrolyte solution 530 to start decomposing because the electrolyte solution 530 cannot receive all the lithium ions extracted from the negative electrode 506. This is one of electrochemical reactions and is referred to as a reduction reaction of an electrolyte solution by a negative electrode. Then, the electron (e⁻) that has flowed to the positive electrode 503 reduces cobalt, which is tetravalent in the lithium cobalt oxide in the charged state, so that the cobalt becomes trivalent or divalent. This reduction reaction causes oxygen release from the lithium cobalt oxide, and the electrolyte solution 530 is decomposed by the released oxygen or the like. This is one of electrochemical reactions and is referred to as an oxidation reaction of an electrolyte solution by a positive electrode.

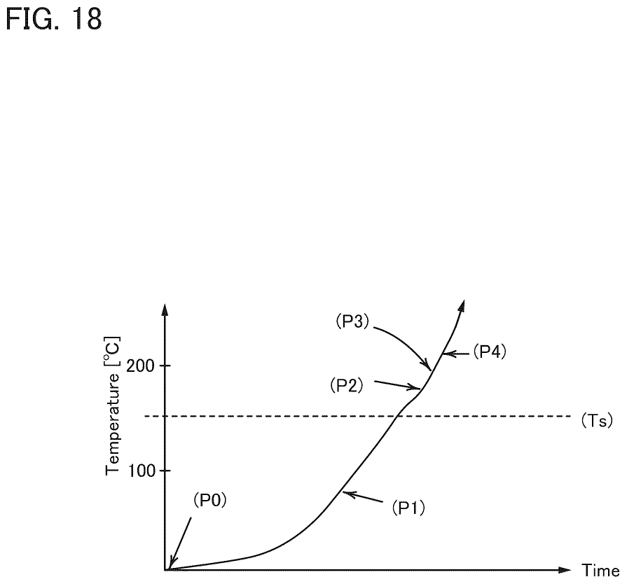

In general, when an internal short circuit of a secondary battery occurs, its temperature changes as shown in the graph of FIG. 18. FIG. 18 is a graph obtained by partly modifying the graph cited from [FIG. 1-11] on page 70 of Non-Patent Document 1. This graph shows the temperature of a secondary battery with respect to time. According to the graph, upon an internal short circuit at (P0), the temperature of the secondary battery increases over time. Specifically, when the temperature of the secondary battery reaches 100° C. or the vicinity thereof because of Joule heat as indicated by (P1), the temperature exceeds the reference temperature (Ts) of the secondary battery. Then, reduction of an electrolyte solution by a negative electrode (the negative electrode is C₆Li when graphite is used) and heat generation are caused at (P2), oxidation of the electrolyte solution by a positive electrode and heat generation of the electrolyte solution are caused at (P3), and heat generation due to thermal decomposition of the electrolyte solution is caused at (P4). Accordingly, the secondary battery enters thermal runaway, resulting in ignition or the like.

In the case where a nail penetration test is performed on a secondary battery using the positive electrode active material 200 described in Embodiment 1 above, the positive electrode active material 200 has a unique effect of inhibiting release of oxygen; thus, it is considered that an oxidation reaction of the electrolyte solution and heat generation can be inhibited.

### REFERENCE NUMERALS

100: graphite particle, 101: silicon particle, 102: binder, 103: AB, 104: mixture, 105: solvent, 106: slurry, 107: negative electrode current collector, 108: negative electrode, 200: positive electrode active material, 200a: surface portion, 200b: inner portion

1. A lithium-ion secondary battery comprising:
a positive electrode, a negative electrode, and an electrolyte,
wherein the positive electrode comprises lithium cobalt oxide with a median diameter (D50) of greater than 12 μm,
wherein the lithium cobalt oxide comprises magnesium in its surface portion, and
wherein the negative electrode comprises a graphite particle, a silicon particle, and a high molecular comprising a carboxy group.

2. The lithium-ion secondary battery according to claim 1,
wherein an average particle diameter of the silicon particles is less than 1 μm.

3. The lithium-ion secondary battery according to claim 1,
wherein an average particle diameter of the graphite particles is greater than or equal to 5 μm.

4. The lithium-ion secondary battery according to claim 1,
wherein in the negative electrode, a weight ratio of the silicon particles is lower than a weight ratio of the graphite particles.

5. The lithium-ion secondary battery according to claim 1,
wherein the high molecular comprising the carboxy group is polyglutamic acid.

6. The lithium-ion secondary battery according to claim 1,
wherein an average particle diameter of the silicon particles is smaller than an average particle diameter of the graphite particles.

7. The lithium-ion secondary battery according to claim 1,
wherein the lithium cobalt oxide has a layered rock-salt crystal structure belonging to a space group R-3m,
wherein the surface portion comprises a basal plane comprising a surface parallel to a (00l) plane of a crystal structure and an edge plane comprising a surface in a direction intersecting the (00l) plane, and
wherein when an EDX linear analysis in a depth direction is performed on the lithium cobalt oxide, a concentration of the magnesium is higher in the basal plane than in the edge plane.

8. A lithium-ion secondary battery comprising:
a positive electrode, a negative electrode, and an electrolyte solution,
wherein the positive electrode comprises lithium cobalt oxide with a median diameter (D50) of greater than 12 μm,
wherein the lithium cobalt oxide comprises magnesium in its surface portion,
wherein the negative electrode comprises a graphite particle, a silicon particle, and a high molecular comprising a carboxy group, and
wherein an average particle diameter of the silicon particles is smaller than an average particle diameter of the graphite particles.

9. The lithium-ion secondary battery according to claim 8,
wherein the lithium cobalt oxide further comprises nickel in the surface portion,
wherein the lithium cobalt oxide comprises a layered rock-salt crystal structure belonging to a space group R-3m,
wherein the surface portion comprises a basal plane comprising a surface parallel to a (00l) plane of the crystal structure and an edge plane comprising a surface in a direction intersecting the (00l) plane, and
wherein when an EDX linear analysis in a depth direction is performed on the lithium cobalt oxide, the lithium cobalt oxide comprises a region where distribution of the magnesium and distribution of the nickel overlap with each other in the edge plane.
